(19) United States
(12) Patent Application Publication
(10) Pub. No.: US 2025/0343762 A1
(43) Pub. Date: Nov. 6, 2025

(54) DISCOVERY OF RESOURCE AVAILABILITY FOR LAYER-3 DETERMINISTIC NETWORK FLOWS IN A WIRELESS COMMUNICATIONS NETWORK

(71) Applicant: Lenovo (Singapore) Pte. Limited, Singapore (SG)

(72) Inventors: Emmanouil Pateromichelakis, Viersen (DE); Dimitrios Karampatsis, Ruislip (GB)

(73) Assignee: Lenovo (Singapore) Pte. Limited, Singapore (SG)

(21) Appl. No.: 18/868,530

(22) PCT Filed: Jul. 25, 2022
(86) PCT No.: PCT/EP2022/070851

§ 371 Date: Nov. 22, 2024

(30) Foreign Application Priority Data
May 25, 2022 (GR) 20220100438

(51) Int. Cl. H04L 47/2416

(52) U.S. Cl. CPC H04L 47/2416

(57) ABSTRACT

There is provided a method for discovering availability of wireless communication system resources for at least one Deterministic Network, DetNet, flow, comprising: receiving DetNet requirement information; using the DetNet requirement information, determining a network resource requirement for at least one network node; obtaining a resource availability indication indicating whether the network resource needed to satisfy the network resource requirement is available; determining a DetNet flow availability indication based on the obtained resource availability indication; and sending the DetNet flow availability indication to one or more network or application nodes.

### FIELD

The subject matter disclosed herein relates generally to the field of implementing for discovery of resource availability for layer-3 deterministic network flows in a wireless communications network. This document defines a method for performance by a network node of a wireless communications network, a network node of a wireless communications network, a method for performance by a user equipment apparatus of a wireless communications network, and a user equipment apparatus of a wireless communications network.

### BACKGROUND

GPP has defined support of deterministic networks since Release 17 (TS 23.700-07 v17.0.0).

In Release 17, support of layer-2 deterministic networks, namely IEEE Time-Sensitive Networking (TSN) based on IEEE802.1q standard, is supported.

To support IEEE TSN, the 5G system (5GS) is configured as a layer-2 bridge as shown in 3GPP TS 23.501 v17.4.0. Support for deterministic systems can be both TSN-based, or 5G-native TSCs.

In this direction, 3GPP Technical Specification Group Service and System Aspects Working Group 6 (SA6) has provided support for deterministic networks for both TSN-based and non-TSN-based architectures. 5GS “TSC” refers to time-sensitive communication services offered within the 5GS (i.e. without integration with a TSN system) by the 5GS for user equipment apparatuses (UEs) connected to the 5GS.

### SUMMARY

A problem with existing deterministic network flow establishment is that of how to identify nodes within a wireless communications network which are aware of the deterministic network, how to determine the availability of resources within a wireless communication network required to support deterministic network traffic, and how to establish deterministic networks in wireless communications networks with end systems which are not aware of the deterministic network.

Disclosed herein are procedures for discovery of resource availability for layer-3 deterministic network flows in a wireless communications network. Said procedures may be implemented by the architectures and apparatuses described herein.

In an aspect, there is provided a method for discovering availability of wireless communication system resources for at least one Deterministic Network, DetNet, flow. The method comprises receiving DetNet requirement information. The method further comprises, using the DetNet requirement information, determining a network resource requirement for at least one network node. The method further comprises obtaining a resource availability indication indicating whether the network resource needed to satisfy the network resource requirement is available. The method further comprises determining a DetNet flow availability indication based on the obtained resource availability indication. The method further comprises sending the DetNet flow availability indication to one or more network or application nodes.

In a further aspect, there is provided a network node of a wireless communication system. The network node comprises a receiver arranged to receive DetNet requirement information. The network node further comprises one or more processors arranged to, using the DetNet requirement information, determine a network resource requirement for at least one other network node. The one or more processors are further arranged to obtain a resource availability indication indicating whether a network resource needed to satisfy the network resource requirement is available. The one or more processors are further arranged to determine a DetNet flow availability indication based on the obtained resource availability indication. The network node further comprises a transmitter arranged to send the DetNet flow availability indication to one or more network or application nodes.

In a yet further aspect, there is provided a method for performance by a user equipment, UE, in a wireless communication system. The method comprises receiving, from one or more network nodes of the wireless communication system, a resource availability request. The resource availability request comprises one or both of: a request for an indication as to whether a network resource needed to satisfy a network resource requirement for a Deterministic Network, DetNet, flow is available; and a request for a condition parameter for a network resource associated with a DetNet flow. The method further comprises determining whether the network resource needed to satisfy the network resource requirement is available and/or measuring the condition parameter. The method further comprises sending, to the one or more network nodes of the wireless communication system, a resource availability response. The resource availability response comprises one or both of: a resource availability indication indicating whether the network resource needed to satisfy the network resource requirement is available; and the measurement of the condition parameter.

In a yet further aspect, there is provided a user equipment, UE, comprising a receiver arranged to receive, from one or more network nodes of the wireless communication system, a resource availability request. The resource availability request comprises one or both of: a request for an indication as to whether a network resource needed to satisfy a network resource requirement for a Deterministic Network, DetNet, flow is available; and a request for a condition parameter for a network resource associated with a DetNet flow. The UE further comprises one or more processors arranged to: determine whether the network resource needed to satisfy the network resource requirement is available; and/or measure the condition parameter. The UE further comprises a transmitter arranged to send, to the one or more network nodes of the wireless communication system, a resource availability response. The resource availability response comprises one or both of: a resource availability indication indicating whether the network resource needed to satisfy the network resource requirement is available; and the measurement of the condition parameter.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for discovery of resource availability for layer-3 deterministic network flows in a wireless communications network will now be described, byway of example only, with reference to the accompanying drawings, in which:

FIG. 1 is a schematic illustration of a network architecture for supporting deterministic communications;

FIG. 2 is a schematic illustration of a further network architecture for supporting SEAL-DD Service;

FIG. 3 is a schematic illustration of a yet further network architecture for supporting IETF deterministic networks;

FIG. 4 is a schematic illustration of a yet further network architecture implementing deterministic flows without relay nodes;

FIG. 5 is a schematic illustration of a yet further network architecture implementing deterministic flows with relay nodes;

FIG. 6 is a schematic illustration of a yet further network architecture implementing deterministic flows in a deterministic network-unaware system;

FIG. 7 is a schematic illustration of a yet further architecture for supporting IETF deterministic network relay nodes in a 5G system;

FIG. 8 is a schematic illustration of a user equipment apparatus that may be used for implementing the methods described herein;

FIG. 9 is a schematic illustration of a network node that may be used for implementing the methods described herein;

FIG. 10 is a schematic depiction of a procedure for discovering the availability of resources of communication links required for the establishing and/or routing deterministic network flows, wherein the end systems are deterministic network-aware;

FIG. 11 is a schematic depiction of a procedure for discovering the availability of resources of communication links required for the establishing and/or routing deterministic network flows, wherein the end systems are deterministic network-unaware;

FIG. 12 is a process flow chart depicting a method for performance by a network entity for discovering availability of wireless communication system resources for at least one deterministic network flow; and

FIG. 13 is a process flow chart depicting a further method for performance by a user equipment apparatus for discovering availability of wireless communication system resources for at least one deterministic network flow.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

In the following, the terminology “DetNet-aware” may be used herein to refer to nodes or systems with or having access to a capability to configure DetNet flow traffic. For example, a DetNet-aware node may comprise or have access to a dedicated DetNet controller or other entity having the capability to configure DetNet flow traffic, e.g. having the capability to provide requirement information as described herein.

In the following, the terminology “DetNet-unaware” may be used herein to refer to nodes or systems that do not have this specific capability or knowledge to configure DetNet flow traffic, i.e. that are not DetNet-aware. According to IETF RFC 8655, an end system may or may not be aware of the DetNet forwarding sub-layer or DetNet service sub-layer. That is, an end system may or may not contain DetNet-specific functionality. End systems with DetNet functionalities may have the same or different forwarding sub-layer as the connected DetNet domain. DetNet end systems are end systems that implement the DetNet service and/or forwarding sub-layers. DetNet unaware end systems can be application servers requiring service proxies through DetNet nodes.

GPP has defined support of deterministic networks since Release 17 (TS 23.700-07 v17.0.0).

In Release 17, support of layer-2 deterministic networks, namely IEEE Time-Sensitive Networking (TSN) based on IEEE802.1q standard, is supported.

To support IEEE TSN, the 5GS system is configured as a layer-2 bridge as shown in 3GPP TS 23.501 v17.4.0. Support for deterministic systems can be both TSN-based, or 5G-native TSCs.

In this direction, 3GPP SA6 has provided support for deterministic networks for both TSN-based and non-TSN-based architectures.

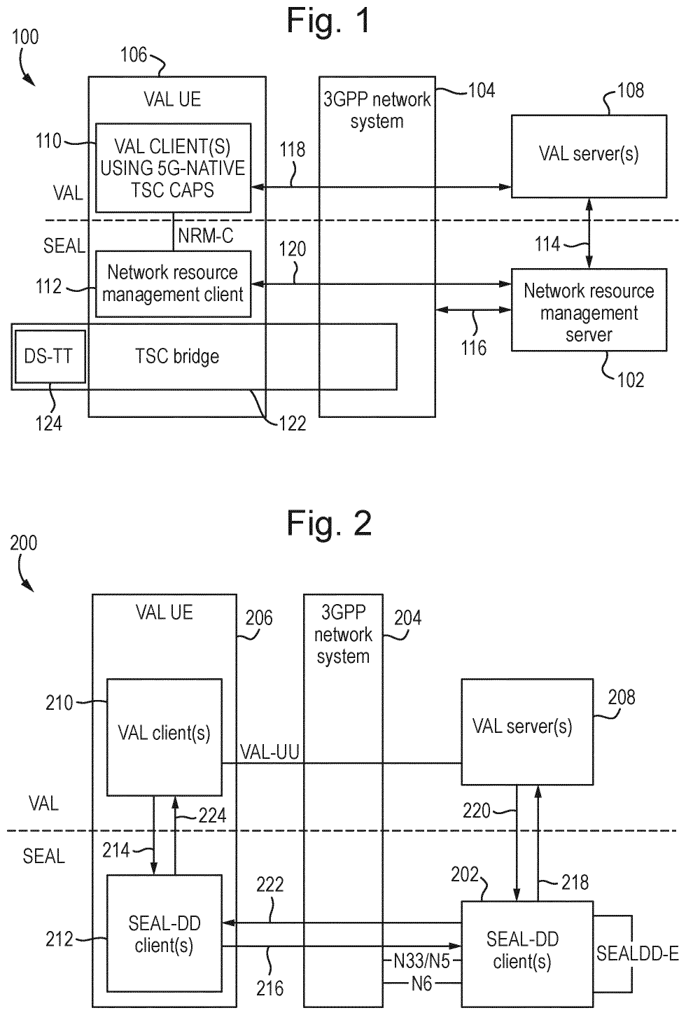

FIG. 1 depicts a network architecture 100 for the 5G TSC which provides a Service Enabler Architecture Layer (SEAL) Network Resource Management (NRM) support for deterministic communications. A SEAL NRM server 102 of the network architecture 100 acts as an Application Function (AF) towards a 5G Core Network 104 and performs coordination of Quality of Service (QoS) flows to fulfill the end-to-end QoS requirements for the UEs 106 involved in the TSC communication. The SEAL NRM server 102 combines the roles of the Time-Sensitive Communications and Time Synchronization Function (TSCTSF) and the Time-Sensitive Communications Central Network Controller (TSC CNC, similar to the TSN CNC in the TSN-integration case), which means that it controls the allocation of resources of TSC communication within the boundaries of the 5G domain.

The network architecture 100 further comprises a Vertical Application Layer (VAL) server 108. The VAL UE 106 includes a VAL client 110 and a NRM client 112.

Upon a request from the VAL server 108 via a NRM-S reference point (indicated in FIG. 1 by a double-headed arrow and the reference numeral 114), the NRM server 102 configures the TSC end-to-end QoS flows in the 5GS. In line with other SEAL service enablers, the SEAL NRM server 102 provides a RESTful interface on the NRM-S reference point. As a TSCTSF, the SEAL NRM server 102 interacts with a 5GS PCF over a Nxx reference point to configure the 5G QoS and TSC assistance information (TSCAI) parameters in the 5GS (indicated in FIG. 1 by a double-headed arrow and the reference numeral 116).

The VAL server 108 is communicatively coupled over VAL-UU with the VAL client 110 of the VAL UE 106 (indicated in FIG. 1 by a double-headed arrow and the reference numeral 118). The SEAL NRM server 102 is communicatively coupled over NRM-UU with the NRM client 112 of the VAL UE 106 (indicated in FIG. 1 by a double-headed arrow and the reference numeral 120).

The network architecture 100 further comprises a TSC bridge 122 spanning the 5GS 104, the VAL UE 106, and a Device Side TSN Translator (DS-TT) 124.

In TS 23.434 v18.0.0, the NRM server 102 provides the following capabilities for TSC (mainly targeting UE to UE interactions):
a TSC stream availability discovery procedure which is used by the VAL server 108 to discover the availability of resources for TSC communication for a given stream specification (i.e., between the target UEs) prior to creating the stream; and
TSC stream creation and deleting procedures with the support of the NRM server 102 (based on resource availability checking).

Furthermore, the 3GPP SA6 has an ongoing Work Item Description (WID), as per TS 23.545 v0.4.0, on Factories of the Future (FF) application layer aspects, wherein the IP connectivity aspects among UEs are discussed (when not using TSN). Such a WID can also potentially accommodate requirements for Layer-3 deterministic networks.

Also, in SA6, SEAL Data Delivery (SEAL-DD) is discussed to provide user plane interaction for data delivery over the enablement layer (TR 23.700-34). FIG. 2 depicts a further network architecture 200 for SEAL-DD Service based on TR 23.700-34 v0.4.0.

The further network architecture 200 comprises a SEAL-DD server 202 which acts as an Application Function (AF) towards a 5G Core Network 204. The architecture 200 further comprises a VAL UE 206 and a VAL server 208. The VAL UE 206 includes a VAL client 210 and a SEAL-DD client 212.

For uplink traffic, the VAL client 210 sends application data traffic to the SEAL-DD client 212 for one or more SEAL-DD services over SEAL-DD-C (indicated in FIG. 2 by a single-headed arrow and the reference numeral 214). After data plane packet processing by the SEAL-DD client 212, the application data traffic is converted to SEAL-DD data traffic and transferred to the SEAL-DD server 202 over SEAL-DD-UU (indicated in FIG. 2 by a single-headed arrow and the reference numeral 216). The SEAL-DD server 202 restores the application data traffic and sends it to the VAL server 208 over SEAL-DD-S (indicated in FIG. 2 by a single-headed arrow and the reference numeral 218). For downlink traffic, the VAL server 208 sends application data traffic to the SEAL-DD server 202 for one or more SEAL-DD services over SEAL-DD-S (indicated in FIG. 2 by a single-headed arrow and the reference numeral 220). After data plane packet processing by the SEAL-DD server 202, the application data traffic is converted to SEAL-DD data traffic and transferred to the SEAL-DD client 212 over SEAL-DD-UU (indicated in FIG. 2 by a single-headed arrow and the reference numeral 222). The SEALDD client 212 restores the application data traffic and sends it to the VAL client 210 over SEALDD-C (indicated in FIG. 2 by a single-headed arrow and the reference numeral 224).

SEAL-DD can also provide support for Ultra-reliable Low-latency Communications (URLLC) traffic for redundant path control as described herein.

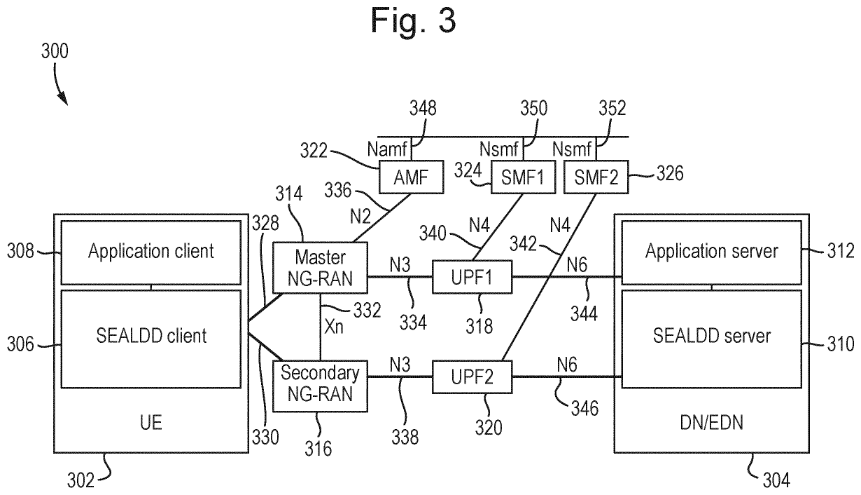

As part of Release 18 of SA2, a new study was agreed in order to support layer-3 deterministic networks (DetNets), namely the IETF DetNet standard as described in IETF RFC 8938 within the 5GS system. FIG. 3 depicts a network architecture 300 in which IETF DetNet support is provided. As can be seen in FIG. 3, SEAL-DD can provide support for URLLC traffic for redundant path control.

The network architecture 300 comprises a UE 302 and a Data Network (DN)/Edge Data Network (EDN) 304. The UE 302 comprises a SEAL DD client 306 coupled to an application client 308. The DN/EDN 304 comprises a SEAL-DD server 310 coupled to an application server 312.

The network further 300 comprises a master New Generation Radio Access Network (NG-RAN) 314, a secondary NG-RAN 316, a first UPF (UPF1) 318, a second UPF (UPF2) 320, an Access Management Function (AMF) 322, a first Session Management Function (SMF1) 324, and a second SMF (SMF2) 326.

The UE 302 is coupled to the master NG-RAN 314 and the secondary NG-RAN 316 via respective communication links 328, 330. The master NG-RAN 314 is further coupled to the secondary NG-RAN 316 via an Xn communication link 332. The master NG-RAN 314 is further coupled to the UPF1 318 by a first N3 communication link 334. The master NG-RAN 314 is further coupled to the AMF 322 by a N2 communication link 336. The secondary NG-RAN 316 is further coupled to the UPF2 320 by a second N3 communication link 338. The UPF1 318 is coupled to the SMF1 324 by a first N4 communication link 340. The UPF2 320 is coupled to the SMF2 326 by a second N4 communication link 342. The DN/EDN 304 is coupled to the UPF1 and the UPF2 via first and second N6 communication links 344, 346, respectively. The AMF 322 is coupled to an Namf communication link 348. The SMF1 324 and the SMF2 326 are coupled to respective Nsmf communication links 350, 352.

The objectives of the Release 18 SID are as follows. The study has the following assumptions:
Only IP-based DetNet is in the scope of the work; Multiprotocol Label Switching (MPLS)-based DetNet is out of its scope.
IP based DetNet traffic is carried in PDU Sessions of IP type. (DetNet over Ethernet TSN is not in the scope of the work as it can be supported based on existing 3GPP and IETF standards.)
The solutions should re-use the functionality of the TSC framework defined in Release 17 where applicable.
The solutions support a request from the DetNet controller entity including DetNet configuration for flow path establishment.
Existing 3GPP routing mechanisms can be re-used for DetNet; no new routing function in the 3GPP system is to be defined.
It is out of the study's scope to extend 3GPP multicast mechanisms, but existing multicast capabilities can be re-used for DetNet communications.
It is out of the study's scope to provide support for edge DetNet node functions in the 3GPP network.

IETF (RFC 8655) has defined DetNet architectures with and without relay nodes (i.e. DetNet-aware nodes). The following definitions are provided.
DetNet system: a DetNet-aware end system, transit node, or relay node.
DetNet node: a DetNet edge node, a DetNet relay node, or a DetNet transit node.
DetNet edge node: an instance of a DetNet relay node that acts as a source and/or destination at a DetNet service sub-layer. For example, it can include a DetNet service sub-layer proxy function for DetNet service protection (e.g., the addition or removal of packet sequencing information) for one or more end systems, it can start or terminate resource allocation at a DetNet forwarding sub-layer, or it can aggregate DetNet services into new DetNet flows.
DetNet relay node: a DetNet node that includes a service sub-layer function that interconnects different DetNet forwarding sub-layer paths to provide service protection.

A DetNet relay node participates in the DetNet service sub-layer. It typically incorporates DetNet forwarding sub-layer functions as well, in which case it is co-located with a transit node.
DetNet transit node: a DetNet node, operating at the DetNet forwarding sub-layer, that utilizes link-layer and/or network-layer switching across multiple links and/or sub-networks to provide paths for DetNet service sub-layer functions. It typically provides resource allocation over those paths.

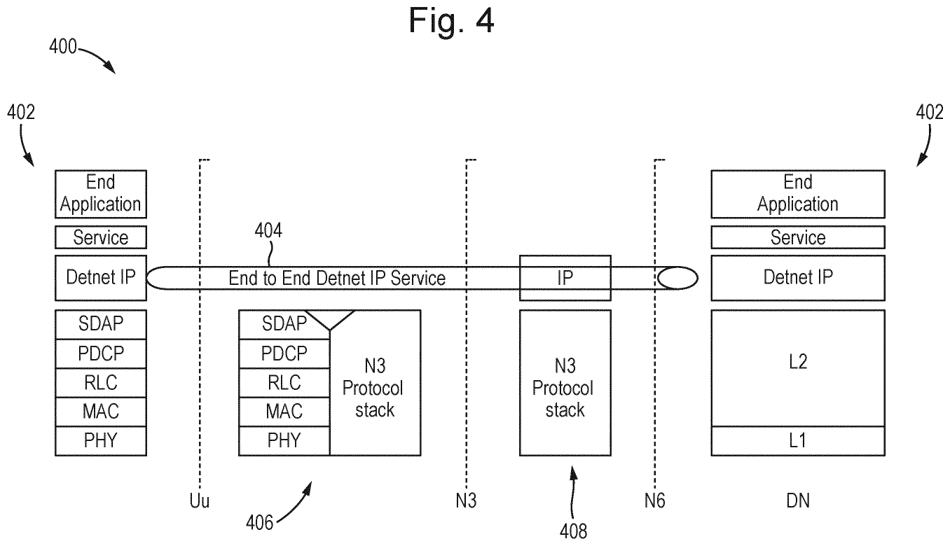

FIG. 4 depicts a further network architecture 400 implementing DetNet flows without relay nodes. The further network architecture 400 comprises a DetNet-aware node 402, and in particular an IETF DetNet end system 402, which receives application packets from a source (which is DetNet-unaware) and encapsulates the packet into a DetNet flow 404 that has particular deterministic characteristics (e.g. specific QoS, delay tolerance, etc.). The DetNet-aware node 402 encapsulates the packet based on information (rules) provided to the DetNet-aware node 402 by a DetNet controller (not shown in FIG. 4). The rules are in the form of a DetNet Yang model as described in draft-ietf-detnet-yang-16. This document contains the specification for configuration and operational data for DetNet flows, e.g. the DetNet flow 404.

The further network architecture 400 further comprises a (DetNet-unaware) Next Generation Node B (gNodeB) 406 and a (DetNet-unaware) User Plane Function (UPF) 408 via which the DetNet flow 404 is routed.

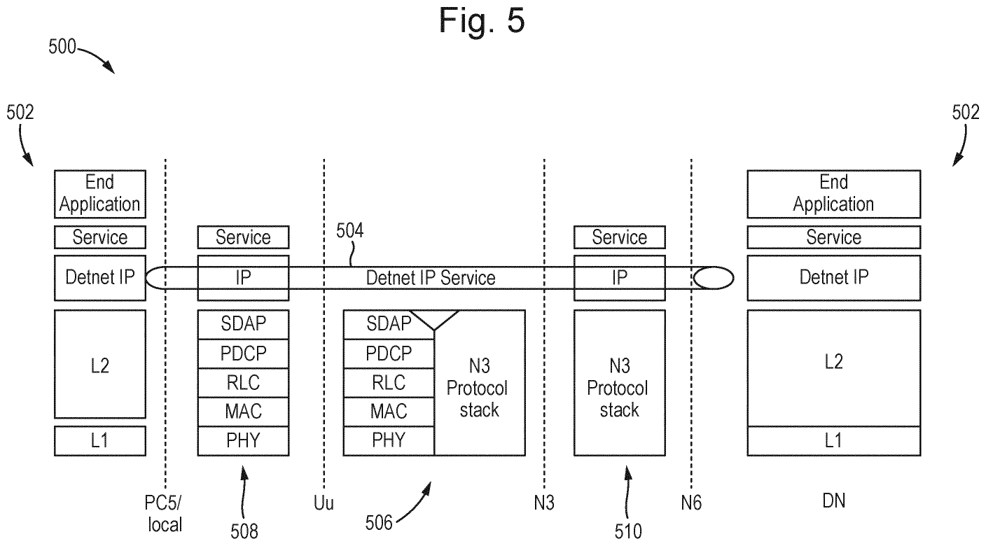

FIG. 5 depicts a further network architecture 500 for implementing DetNet flows with relay nodes. The further network architecture 500 comprises IETF DetNet end systems 502 between which DetNet flows 504 are routed. The further network architecture 500 further comprises DetNet-aware relay nodes and a DetNet-unaware gNB 506. In this embodiment, the DetNet-aware relay nodes include, respectively, a UE 508 and a UPF 510.

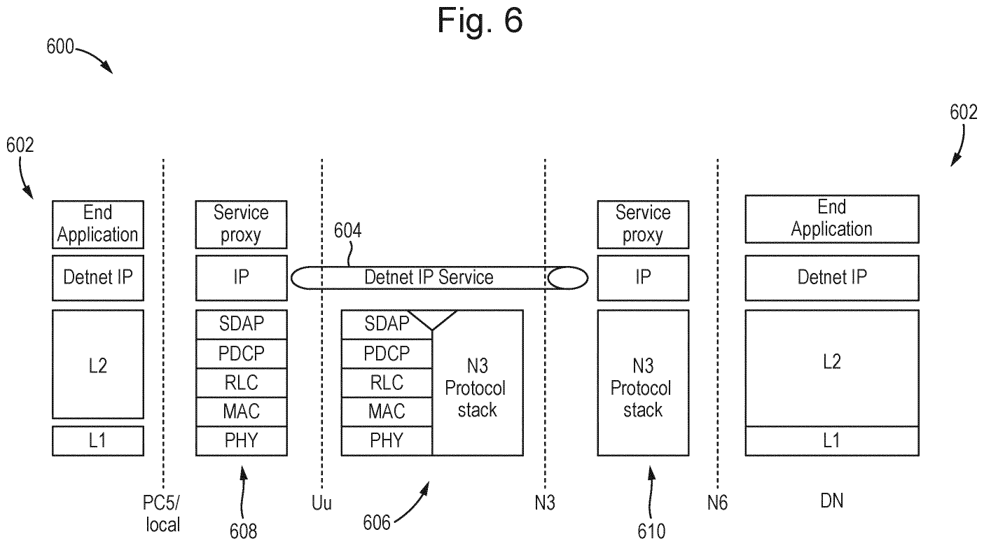

FIG. 6 depicts a further network architecture 600 for implementing DetNet flows in a DetNet-unaware system, i.e. with IP DetNet-unaware end systems 602 between which DetNet flows 604 are to be routed. The further network architecture 600 further comprises DetNet-aware relay nodes and a DetNet-unaware gNB 606. In this embodiment, the DetNet-aware relay nodes include, respectively, a UE 608 and a UPF 610.

An assumption, in each of the implementations of FIGS. 4 and 5, is that the IETF DetNet end system 402 (which is a DetNet-aware node) has already encapsulated application flows into a DetNet flows 404 and a relay node forwards the DetNet flow 404 according to the DetNet flow deterministic characteristics as configured by a DetNet controller.

As mentioned in RFC 8655, “in general, if a DetNet flow passes through one or more DetNet-unaware network nodes between two DetNet nodes providing the DetNet forwarding sub-layer for that flow, there is a potential for disruption or failure of the DetNet QoS. A network administrator needs to 1) ensure that the DetNet-unaware network nodes are configured to minimize the chances of packet loss and delay and 2) provision enough extra buffer space in the DetNet transit node following the DetNet unaware network nodes to absorb the induced latency variations.”

FIGS. 4 to 6 provide respective illustrations of the protocol stack (UP) options for 3 different possible implementations: 1) without relay nodes; 2) with relay nodes; and 3) with DetNet unaware end systems. Such protocol stack options show the use of a UE and UPF as DetNet-aware relay nodes or as DetNet-unaware nodes, as well as the use of proxies at the 3GPP nodes, in the case when the end system is unaware (the end systems 602 of FIG. 6). The service sublayer in these options is configured by the DetNet controller with policies (e.g. redundancy, reordering etc.). For simplicity, the forwarding layer (which can be between IP and service sublayer) is not shown in each of FIGS. 4 to 6.

Based on the assumptions outlined above, it is possible to have different configurations needed for 3GPP system entities suitable for routing DetNet flows. For example, the configuration of the UE and UPF in the case in which they are relay nodes is performed by the DetNet controller. On the other hand, for 3GPP entities, e.g. a UPF, a Radio Access Network (RAN), a UE, etc., which are DetNet-unaware nodes, a Mobile Network Operator (MNO) or application service provider (via an AF) can support the configuration of service proxies and the configuration of unaware nodes to avoid service degradation.

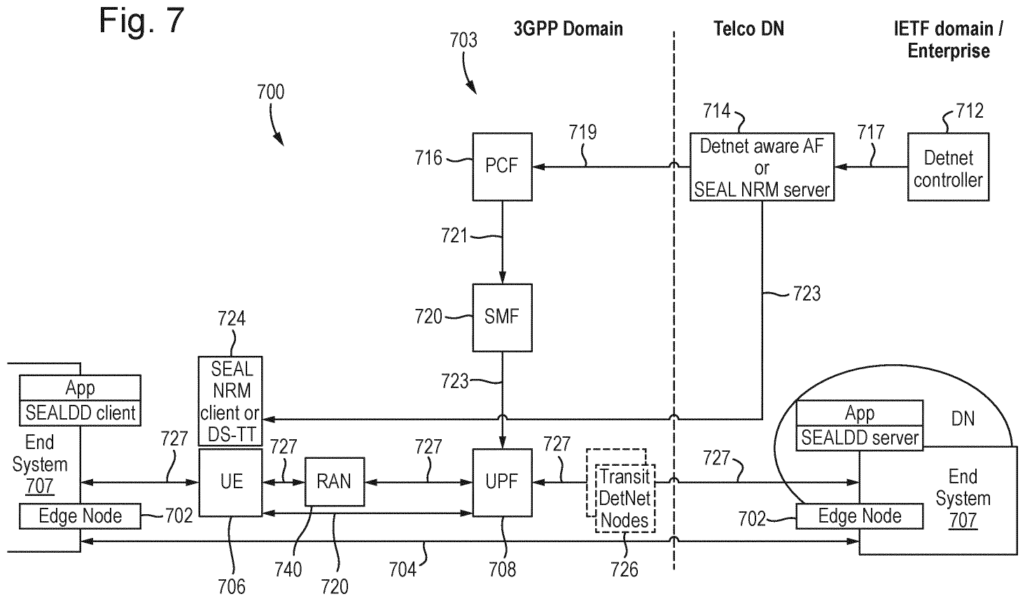

FIG. 7 depicts a further (generic) architecture 700 proposed to support IETF DetNet relay nodes in a 5GS.

The further architecture 700 comprises an application 701. The application 701 is a source or destination application at a corresponding edge node 702. The application 701 can be a smart grid application, an industrial application, and/or another type of application. Use cases of such applications are discussed in IETF RFC8578.

The edge nodes 702 may be a 3GPP-network 703 or non-network node which is a source or destination and can be located within a DetNet system or outside a DetNet system (e.g. at the edge). The DetNet flow 704 is routed between the edge nodes 702. In this embodiment, the edge node 702 is behind the relay nodes of the system, i.e. the relay UE 706 and the relay UPF 708 at the DN side. In this embodiment, the edge nodes are between, or define, respective end systems 707 (namely device-side and network-side end systems 707). The end systems 707 may be DetNet-aware or DetNet-unaware. The UE 706 may serve as a L3 relay or edge for the DetNet flow 704 traffic. Such a node is assumed to be a 3GPP-networked node. The relay UPF 708 (local or anchor) may serve as a L3 relay from the network side for the DetNet flow 704.

The further architecture 700 further comprises a DetNet-unaware UPF or RAN node 710 which is not DetNet-aware.

The further architecture 700 further comprises a DetNet controller 712 residing in the IETF DetNet domain. The DetNet controller 712 configures all the entities involved along the DetNet flow 704 path (i.e. edge, relay, and transit nodes). The DetNet controller 712 is like a Software-defined Networking (SDN) controller located at enterprise/Operational Technology (OT) premises.

The further architecture 700 further comprises a DetNet-aware AF 714 or a SEAL-S NRM server 714. The DetNet-aware AF 714 receives configuration information from a DetNet controller 712 (located outside of the 3GPP domain 703) in the form of DetNet Yang traffic profiles. The configuration information may include application flows and/or traffic profiles associated with the DetNet flow 704. The DetNet-aware AF 714 converts the information into TSCAI containing QoS information, the TSCAI being sent to a PCF 716 within the 3GPP system 703. Such an AF 714 can also provide topology information to the DetNet controller 712 for supporting configuration phase and relay selection. The receiving by the DetNet-aware AF 714 or SEAL NRM server 714 of the configuration information is indicated in FIG. 7 by a single-headed arrow and the reference numeral 717. The sending by the DetNet-aware AF 714 or SEAL NRM server 714 of the TSCAI to the PCF 716 is indicated in FIG. 7 by a single-headed arrow and the reference numeral 719.

The further architecture 700 further comprises a SMF 720 in the 3GPP domain 703. The PCF 714 determines Policy and Charging Control (PCC) rules based on the QoS information, and based thereon instructs the SMF 718 to configure a PDU Session 720 (used for DetNet flow 704) with the UE 706 to support the QoS characteristics of the DetNet flow 704. The instructing by the PCF 716 of the SMF 718 using the PCC rules is indicated in FIG. 7 by a single-headed arrow and the reference numeral 721. The configuring by the SMF 720 of the PDU Session 720 is indicated in FIG. 7 by a single-headed arrow and the reference numeral 723.

The relay UE 706 further comprises a DS-TT 724 or a SEAL-C NRM client 724: The DS-TT 724 or the SEAL-C NRM client 724 is used to translate configuration policies received at the relay UE 706 into communication-related configurations, and to locally monitor locally traffic of the DetNet flow 704.

The DS-TT 724 or the SEAL NRM client 724 may be connected to, and configured to receive data from, the DetNet-aware AF 714 or the SEAL NRM server 714, as indicated in FIG. 7 by a single-headed arrow and the reference numeral 725.

Data may be relayed between the device-side edge node 702 and the UE 706, between the UE 706 and the RAN 710, between the RAN 710 and the UPF 708, and (via one or more transit DetNet nodes 726) between the UPF 708 and the network-side edge node 702. These relays, or “hops”, are indicated in FIG. 7 by double-headed arrows and the reference numeral 727.

Problems to be solved include:
how to discover the availability of resources, corresponding to the different hops (e.g., UE to UE and/or UE to UPF) of the end-to-end path, for supporting the DetNet flow traffic;
how to discover the available DetNet-aware network nodes and their resources; and
when to assume that the end systems are DetNet-unaware.

The methods and apparatuses described herein present a solution to this problem.

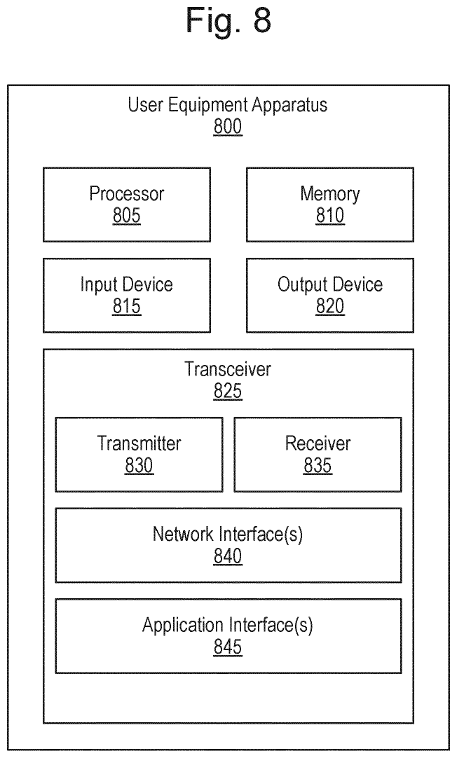

FIG. 8 depicts a UE 800 that may be used for implementing the methods described herein. The UE 800 is used to implement one or more of the solutions described herein. The UE 800 is in accordance with one or more of the UEs described in embodiments herein. In particular, the UE 800 is in accordance with the UEs 106, 508, 608, 706 described above, and as such the reference numeral 800 is used hereinafter to indicate a UE in accordance with the any of the UEs 106, 508, 608, 706. The UE 800 includes a processor 805, a memory 810, an input device 815, an output device 820, and a transceiver 825.

The input device 815 and the output device 820 may be combined into a single device, such as a touchscreen. In some implementations, the UE 800 does not include any input device 815 and/or output device 820. The UE 800 may include one or more of: the processor 805, the memory 810, and the transceiver 825, and may not include the input device 815 and/or the output device 820.

As depicted, the transceiver 825 includes at least one transmitter 830 and at least one receiver 835. The transceiver 825 may communicate with one or more cells (or wireless coverage areas) supported by one or more base units. The transceiver 825 may be operable on unlicensed spectrum. Moreover, the transceiver 825 may include multiple UE panels supporting one or more beams. Additionally, the transceiver 825 may support at least one network interface 840 and/or application interface 845. The application interface(s) 845 may support one or more APIs. The network interface(s) 840 may support 3GPP reference points, such as Uu, N1, PC5, etc. Other network interfaces 840 may be supported, as understood by one of ordinary skill in the art.

The processor 805 may include any known controller capable of executing computer-readable instructions and/or capable of performing logical operations. For example, the processor 805 may be a microcontroller, a microprocessor, a central processing unit (“CPU”), a graphics processing unit (“GPU”), an auxiliary processing unit, a field programmable gate array (“FPGA”), or similar programmable controller. The processor 805 may execute instructions stored in the memory 810 to perform the methods and routines described herein. The processor 805 is communicatively coupled to the memory 810, the input device 815, the output device 820, and the transceiver 825.

The processor 805 may control the UE 800 to implement the UE behaviors described herein. The processor 805 may include an application processor (also known as “main processor”) which manages application-domain and operating system (“OS”) functions and a baseband processor (also known as “baseband radio processor”) which manages radio functions.

The memory 810 may be a computer readable storage medium. The memory 810 may include volatile computer storage media. For example, the memory 810 may include a RAM, including dynamic RAM (“DRAM”), synchronous dynamic RAM (“SDRAM”), and/or static RAM (“SRAM”). The memory 810 may include non-volatile computer storage media. For example, the memory 810 may include a hard disk drive, a flash memory, or any other suitable non-volatile computer storage device. The memory 810 may include both volatile and non-volatile computer storage media.

The memory 810 may store data related to implement a traffic category field as described herein. The memory 810 may also store program code and related data, such as an operating system or other controller algorithms operating on the UE 800.

The input device 815 may include any known computer input device including a touch panel, a button, a keyboard, a stylus, a microphone, or the like. The input device 815 may be integrated with the output device 820, for example, as a touchscreen or similar touch-sensitive display. The input device 815 may include a touchscreen such that text may be input using a virtual keyboard displayed on the touchscreen and/or by handwriting on the touchscreen. The input device 815 may include two or more different devices, such as a keyboard and a touch panel.

The output device 820 may be designed to output visual, audible, and/or haptic signals. The output device 820 may include an electronically controllable display or display device capable of outputting visual data to a user. For example, the output device 820 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 820 may include a wearable display separate from, but communicatively coupled to, the rest of the UE 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

The output device 820 may include one or more speakers for producing sound. For example, the output device 820 may produce an audible alert or notification (e.g., a beep or chime). The output device 820 may include one or more haptic devices for producing vibrations, motion, or other haptic feedback. All, or portions, of the output device 820 may be integrated with the input device 815. For example, the input device 815 and output device 820 may form a touchscreen or similar touch-sensitive display. The output device 820 may be located near the input device 815.

The transceiver 825 communicates with one or more network functions of a mobile communication network via one or more access networks. The transceiver 825 operates under the control of the processor 805 to transmit messages, data, and other signals and also to receive messages, data, and other signals. For example, the processor 805 may selectively activate the transceiver 825 (or portions thereof) at particular times in order to send and receive messages.

The transceiver 825 includes at least one transmitter 830 and at least one receiver 835. The one or more transmitters 830 may be used to provide uplink communication signals to a base unit of a wireless communications network. Similarly, the one or more receivers 835 may be used to receive downlink communication signals from the base unit. Although only one transmitter 830 and one receiver 835 are illustrated, the UE 800 may have any suitable number of transmitters 830 and receivers 835. Further, the transmitter(s) 830 and the receiver(s) 835 may be any suitable type of transmitters and receivers. The transceiver 825 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 825, transmitters 830, and receivers 835 may be implemented as physically separate components that access a shared hardware resource and/or software resource, such as for example, the network interface 840.

One or more transmitters 830 and/or one or more receivers 835 may be implemented and/or integrated into a single hardware component, such as a multi-transceiver chip, a system-on-a-chip, an Application-Specific Integrated Circuit (“ASIC”), or other type of hardware component. One or more transmitters 830 and/or one or more receivers 835 may be implemented and/or integrated into a multi-chip module. Other components such as the network interface 840 or other hardware components/circuits may be integrated with any number of transmitters 830 and/or receivers 835 into a single chip. The transmitters 830 and receivers 835 may be logically configured as a transceiver 825 that uses one more common control signals or as modular transmitters 830 and receivers 835 implemented in the same hardware chip or in a multi-chip module.

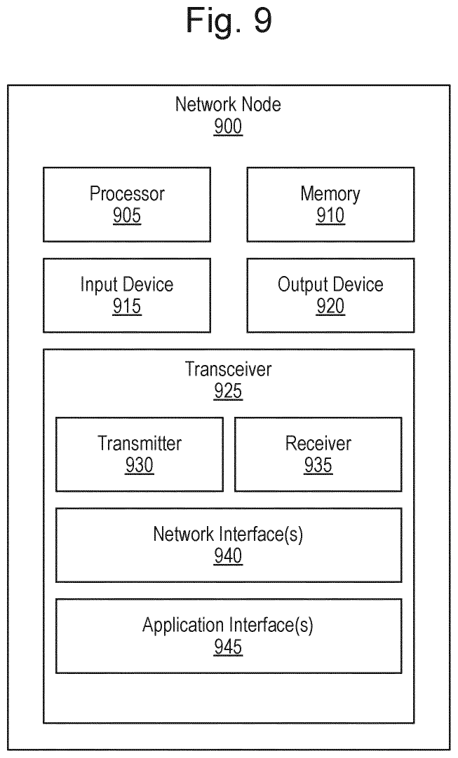

FIG. 9 depicts further details of the network node 900 that may be used for implementing the methods described herein. The network node 900 may be one implementation of an entity in the wireless communications network, e.g. in one or more of the wireless communications networks described herein. The network node 900 may be, for example, the UE 200 and/or the UEs 106, 508, 608, 706 described above, or a Network Function (NF) or Application Function (AF), or another entity, of one or more of the wireless communications networks of embodiments described herein. The network node 900 includes a processor 905, a memory 910, an input device 915, an output device 920, and a transceiver 925.

The input device 915 and the output device 920 may be combined into a single device, such as a touchscreen. In some implementations, the network node 900 does not include any input device 915 and/or output device 920. The network node 900 may include one or more of: the processor 905, the memory 910, and the transceiver 925, and may not include the input device 915 and/or the output device 920.

As depicted, the transceiver 925 includes at least one transmitter 930 and at least one receiver 935. Here, the transceiver 925 communicates with one or more remote units 900. Additionally, the transceiver 925 may support at least one network interface 940 and/or application interface 945. The application interface(s) 945 may support one or more APIs. The network interface(s) 940 may support 3GPP reference points, such as Uu, N1, N2 and N3. Other network interfaces 940 may be supported, as understood by one of ordinary skill in the art.

The processor 905 may include any known controller capable of executing computer-readable instructions and/or capable of performing logical operations. For example, the processor 905 may be a microcontroller, a microprocessor, a CPU, a GPU, an auxiliary processing unit, a FPGA, or similar programmable controller. The processor 305 may execute instructions stored in the memory 910 to perform the methods and routines described herein. The processor 905 is communicatively coupled to the memory 910, the input device 915, the output device 920, and the transceiver 925.

The memory 910 may be a computer readable storage medium. The memory 910 may include volatile computer storage media. For example, the memory 910 may include a RAM, including dynamic RAM (“DRAM”), synchronous dynamic RAM (“SDRAM”), and/or static RAM (“SRAM”). The memory 910 may include non-volatile computer storage media. For example, the memory 910 may include a hard disk drive, a flash memory, or any other suitable non-volatile computer storage device. The memory 910 may include both volatile and non-volatile computer storage media.

The memory 910 may store data related to establishing a multipath unicast link and/or mobile operation. For example, the memory 910 may store parameters, configurations, resource assignments, policies, and the like, as described herein. The memory 910 may also store program code and related data, such as an operating system or other controller algorithms operating on the network node 900.

The input device 915 may include any known computer input device including a touch panel, a button, a keyboard, a stylus, a microphone, or the like. The input device 915 may be integrated with the output device 920, for example, as a touchscreen or similar touch-sensitive display. The input device 915 may include a touchscreen such that text may be input using a virtual keyboard displayed on the touchscreen and/or by handwriting on the touchscreen. The input device 915 may include two or more different devices, such as a keyboard and a touch panel.

The output device 920 may be designed to output visual, audible, and/or haptic signals. The output device 920 may include an electronically controllable display or display device capable of outputting visual data to a user. For example, the output device 920 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 900, such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

The output device 920 may include one or more speakers for producing sound. For example, the output device 920 may produce an audible alert or notification (e.g., a beep or chime). The output device 920 may include one or more haptic devices for producing vibrations, motion, or other haptic feedback. All, or portions, of the output device 920 may be integrated with the input device 915. For example, the input device 915 and output device 920 may form a touchscreen or similar touch-sensitive display. The output device 920 may be located near the input device 915.

The transceiver 925 includes at least one transmitter 930 and at least one receiver 335. The one or more transmitters 930 may be used to communicate with the UE, as described herein. Similarly, the one or more receivers 935 may be used to communicate with network functions in the PLMN and/or RAN, as described herein. Although only one transmitter 930 and one receiver 935 are illustrated, the network node 900 may have any suitable number of transmitters 930 and receivers 935. Further, the transmitter(s) 930 and the receiver(s) 935 may be any suitable type of transmitters and receivers.

The methods and apparatuses described herein provide a mechanism, e.g. at an application layer entity (AF, SEAL, middleware), for supporting the discovery of availability of resources of communication links required for establishing and/or routing DetNet flows. An embodiment of the method comprises:
Receiving requirement information from the DetNet controller or VAL/application server/entity to perform the DetNet flow resource/QoS management. Such requirement information can be in form of a request or a subscription. In the case wherein DetNet flow is to be established between one or more DetNet-unaware end systems, the requirement information may include Yang/Netconf traffic profiles for the DetNet flows. In the case of DetNet-unaware end systems, the requirement information may be sent from the VAL/application server and may also provide a request for discovering/assisting node selection, thereby to serve as a service sublayer proxy.
If the requirement information, e.g. a request, itself comes from a DetNet-unaware end system, discovering, by the application entity, the DetNet controller and requesting and/or receiving the requirement information comprising the Yang profiles including the involved DetNet nodes.
Translating, e.g. unpacking and/or reorganising, the requirement information comprising the Yang traffic profiles, for the involved 3GPP nodes (e.g. UEs, UPF), e.g. based on the IP addresses and the Key Performance Indicators (KPIs) over different hops.
Determining, based on the translated requirement information, a resource requirement for given communication links, and requesting an availability of resources for each of the links from the corresponding control/monitoring entity (e.g. at a UE or 5G Core Network or DN). Such links may be, e.g., UE-to-UE or UE-to-UPF or UE/UPF-to-edge/transit node(s).
Receiving the requested resource availability for the given communication links, and optionally correlating the resource availabilities over different links or hops to provide an end-to-end resource availability (e.g. in the case in which we have UE-to-UE-to-UPF-to-transit node hops).
Providing one or more resource discovery reports to the application server/entity or DetNet controller, based on the resource requirement and the resource availability (and/or correlated resource availabilities).

In an embodiment, there is provided a procedure and architecture for discovering the availability of resources of communication links required for the establishing and/or routing DetNet flows, wherein the end systems are DetNet-aware.

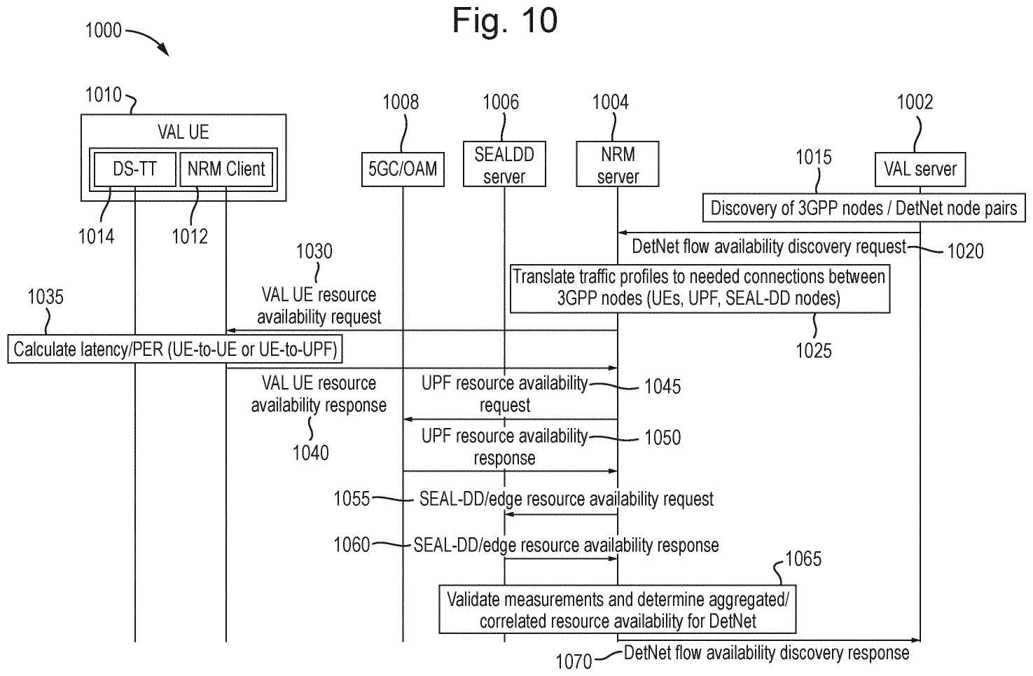

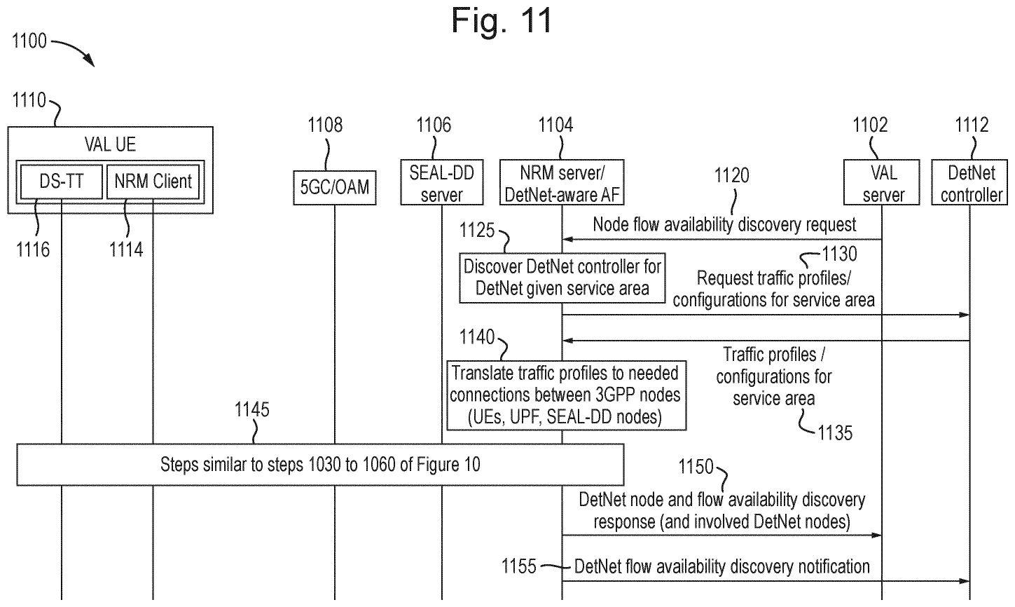

As a precondition to this procedure, the UE(s) of interest has an established IP PDU session and includes a DS-TT or a DetNet Function, and/or a SEAL NRM client (which is configured and connected to the SEAL NRM server). The DetNet function may support Edge, Relay, Transit node capability as described in RFC 8655. Inclusion of a DS-TT is shown in FIG. 10.

FIG. 10 depicts the procedure 1000 for discovering the availability of resources of communication links required for the establishing and/or routing DetNet flows, wherein the end systems are DetNet-aware.

In this embodiment, the network architecture comprises a VAL server 1002, a NRM server 1004, a SEAL-DD server 1006, a 5G Core Network (5GC) or an OAM 1008, and a VAL UE 1010. The VAL UE 1010 comprises a NRM client 1012 and a DS-TT 1014. In this embodiment, the VAL server 1002 may be in accordance with the VAL server described in embodiments above. The NRM server 1004 may be in accordance with the NRM server described in embodiments above. The SEAL-DD server 1006 may be in accordance with the SEAL-DD server described in embodiments above. The 5GC 1008 may be in accordance with the 3GPP system(s) described in embodiments above.

The VAL UE 1010 may be in accordance with one or more of the UEs described in embodiments above. The NRM client 1012 and/or the DS-TT 1014 may, respectively, be in accordance with the NRM client and the DS-TT described in embodiments above.

In this embodiment, the VAL server 1002 (if not the DetNet controller) discovers an available pair of DetNet nodes, i.e. DetNet-aware nodes, within the 3GPP network, for example a UE-to-UE DetNet node pair or a UE-to-UPF DetNet node pair, in which case two DetNet end systems communicate via—the DetNet node pair. In this embodiment the VAL server is a DetNet aware node (and can be the DetNet controller) or can be an application server interacting with the DetNet controller and performs the discovery of available nodes through the controller. The discovering, by the VAL server 1002, of the available pair of DetNet nodes is indicated in FIG. 10 by the reference numeral 1015. In other embodiments, the VAL server 1002 may discover a different number of available DetNet nodes, e.g. one node, three nodes, four nodes, five nodes, or more nodes.

In this embodiment, the NRM server 1004 receives requirement information from the VAL server (the VAL server optionally including a DetNet controller and/or an application-specific server) via a NRM-S reference point. The requirement information may include a request to discover connectivity and available resources/QoS characteristics for one or more hops passing from at least one 3GPP networked node of the discovered available pair of DetNet nodes (e.g. UEs, a UPF, a SEAL-DD server, etc.) for a DetNet flow. The VAL server 1002 can provide in this requirement information, or in this request, one or more Yang/Netconf traffic models (the DetNet Yang model(s) being as described in draft-ietf-detnet-yang-16) which provide source/destination IP addresses as well as configurations for the edge/relay/transit DetNet nodes. This receiving by the NRM server 1004 of requirement information from the VAL server 1002 is indicated in FIG. 10 by a single-headed arrow and the reference numeral 1020.

Table 1 below provides a summary of information elements which may be included within the DetNet flow availability discovery request.

TABLE 1
DetNet flow availability discovery request,
including requirement information.

| Information element | Description |
|---|---|
| Requester Identity | The identity of the entity performing the request. |
| DetNet profiles | DetNet Yang traffic profiles including the app flows |
| | and traffic profiles/characteristics. Such information |
| | may also include the mapping between app flows |
| | and DetNet flows (more than one app flow can |
| | correspond to a DetNet flow). |
| Area of | The geographical or topological area for which the |
| interest/Service | request applies. |
| Area | |
| Time Vadility | Time validity for the request. |
| S-NSSAI or | If application has preference on a certain slice or |
| Network Slice | slice instance, the discovery of resources can be |
| Instance (NSI) | for the requested slice based on S-NSSAI or NSI. |
| DNN/DNAI | Provides description on the DNN and/or DNAI |
| | when the DetNet node resides at the DN/EDN (this |
| | to be used for identifying the UPF). |
| Application Server | The VAL server or application or application profile |
| or VAL server | for which the discovery is requested. this is for the |
| ID, application | case when the request is indirectly provided via the |
| ID, application | requester (e.g. VAL server is behind the DetNet |
| profile or type | controller) |
| Reporting | Identifies how the reporting shall occur (e.g. based |
| configuration | on thresholds, periodically, event-based) |
| Information | the filter may specify a PLMN/NPN, a service |
| filter | provider |

In Table 1 and the other tables presented herein, inclusion of information elements of status “M” in the DetNet flow availability discovery request may, in some embodiments, be mandatory. In Table 1 and the other tables presented herein, inclusion of information elements of status “O” in the DetNet flow availability discovery request may, in some embodiments, be optional.

In this embodiment, the NRM server 1004 translates the requirement information, e.g. including the DetNet Yang traffic profiles into identities of the involved 3GPP nodes (based on the IP addresses), the required communication link(s) between the nodes, and the network resource requirements over these nodes. This translating by the NRM server 1004 of the requirement information is indicated in FIG. 10 by the reference numeral 1025.

Depending on the types/identities of the required communication link(s) between the available nodes (e.g., UE-to-UE, or UE-to-UPF, or UE-to-SEAL-DD or UPF-to-SEAL-DD), the NRM server 1004 performs at least one the following actions.

In the case in which one of the available DetNet nodes (i.e. one of the nodes involved in the required communication link(s)) is the VAL UE 1010, the NRM server 1004 sends a VAL UE resource availability request to the VAL UE 1010, the VAL UE 1010 being identified by its address (e.g. provided in the requirement information). This request can include a request for a determination of availability for UE-to-UE links. In this case, it either provides a request for resource availability per-UE or a request for the VAL UE 1010 to also indicate that for a resource availability of a further VAL UE should be reported. The resource availability request may include a request for the VAL UE 1010 to provide a resource availability indicator and/or a condition parameter associated with the DetNet flow, and/or associated with the VAL UE 1010 and/or hops involving the VAL UE 1010. The NRM server 1004 can also, e.g. prior to this, request/receive a VAL UE ID (GPSI) by 5GC (BSF) based on an AF UE ID retrieval procedure (as defined in TS 23.502 v17.4.0). This sending by the NRM server 1004 of the VAL UE resource availability request to the NRM client 1012 of the VAL UE 1010 is indicated in FIG. 10 by a single-headed arrow and the reference numeral 1030.

Table 2 below provides a summary of information elements which may be included within the VAL UE resource availability request.

TABLE 2
VAL UE resource availability request.

| Information | |
|---|---|
| element | Description |
| VAL UE ID(s) | List of VAL UEs whose resource availability is |
| | requested. Such ID can be the external ID (e.g. |
| | GPSI) or the application client ID at the VAL UE |
| VAL group ID | The group ID used for the VAL group for which |
| | availability data is requested. |
| List of DetNet | List of DetNet flows or app flows for which resource |
| flow IDs or | availability is requested. |
| app flow IDs | |
| Resource | It describes the requirements on the resources |
| availability | availability and conditions such as load, latency, |
| and conditions | channel losses, measurement time period, |
| requirements | aggregation granularity. |
| VAL application | Optionally, the VAL application or service for which |
| or service | the request applies |
| ID and type | |
| Reporting | Identifies how the reporting shall occur (e.g. based |
| configuration | on thresholds, periodically, event-based) |
| Information | the filter may specify a PLMN/NPN, a service |
| filter | provider |
| VAL UE IP | The IP address per VAL UE in the list |
| addresses | |

In some embodiments, only one of the VAL UE ID(s) or the VAL group ID is included within the VAL UE resource availability request.

In this VAL UE case, the NRM client 1012 of the VAL UE 1010 interacts with the DS-TT 1014 (if the DS-TT exists) to instruct the DS-TT 1014 to calculate, as requested, a (e.g. per-UE) resource availability and/or a condition parameter (e.g. a latency between respective DS-TTs of UEs of the pair of DetNet nodes which are to form the DetNet flow path). Latency, for example, may include the DS-TT residence times, Packet Delay Budgets (PDBs), and propagation delays). This interacting of the NRM client 1012 with the DS-TT 1014 thereby to calculate a resource availability and/or a condition parameter is indicated in FIG. 10 by the reference numeral 1035.

In this VAL UE case, the NRM client 1012 sends, i.e. returns, to the NRM server 1004 a VAL UE resource availability response including data as per the VAL UE resource availability request. The VAL UE resource availability response may include the resource availability indication and/or the condition parameter. This sending of the VAL UE resource availability response by the VAL UE 1010 to the NRM server 1004 is indicated in FIG. 10 by a single-headed arrow and the reference numeral 1040.

Table 3 below provides a summary of information elements which may be included within the VAL UE resource availability response.

TABLE 3
VAL UE resource availability response.

| Information | |
|---|---|
| element | Description |
| VAL UE ID(s) | List of VAL UEs whose resource availability is |
| | reported. |
| VAL group ID | The group ID used for the VAL group for which |
| | availability data is reported. |
| List of DetNet | List of DetNet flows or app flows for which resource |
| flow IDs or | availability is reported. |
| app flow IDs | |
| Resource | Indicates whether the requested VAL UE resource |
| availability | is available. |
| indication | |
| Resource | Provides measurements on conditions such as |
| measurements | load, latency, channel losses, measurement time |
| | period, aggregation granularity. |
| Resource | Provides statistics on conditions such as load, |
| availability | latency, channel losses, measurement time period, |
| and condition | aggregation granularity. |
| statistics | |
| Resource | Provides predictions from the VAL UE side on |
| availability | conditions such as load, latency, channel losses, |
| and condition | measurement time period, aggregation granularity. |
| predictions | |
| L3 Relay | The optional indication that the VAL UE can serve |
| capability | as L3 relay |
| indication | |

Time and area of reporting validity

In some embodiments, only one of the VAL UE ID(s) or the VAL group ID is included within the VAL UE resource availability response.

The NRM server 1004 also queries the availability and status/resource usage of a UPF of the 5GC 1008, i.e. sends a UPF resource availability request and receives a UPF resource availability response, for example in one or more of the following ways:
the NRM server 1004 may request and receive a UPF status or UPF analytics from an OAM, and specifically from a Performance Monitoring (PM) and/or a Management Data Analytics Service (MDAS) via OAM Application Programming Interfaces (APIs);
the NRM server 1004 may consume from a Network Data Analytics Function (NWDAF) a UPF load analytics service for the UPF or area of interest; and
the NRM server 1004 may request and receive from the 5GC a UPF status and/or availability over the control plane. The UPF availability can be provided to a SMF of the 5GC 1008 by the NRM server 1004 as part of UPF Provisioning Information (associated with the UPF). Such information is discussed in TS23.502 v4.17.6. Here, we can either assume that an AF triggers the SMF to query UPF Provisioning Information or that an AF directly subscribes to the NRM server 1004 to receive UPF Provisioning Information for the UPF requested. The UPF Provisioning Information consists of a list of (S-NSSAI, DNN), UE IPv4 Address Ranges and/or IPv6 Prefix Range(s) per (S-NSSAI, DNN), and a SMF Area Identity for an area which the UPF can serve, etc.

The sending, by the NRM server 1004 to one or more entities of the 5GC 1008, of the UPF resource availability request is indicated in FIG. 10 by a single-headed arrow and the reference numeral 1045. The receiving, by the NRM server 1004 from one or more entities of the 5GC 1008, of the UPF resource availability response is indicated in FIG. 10 by a single-headed arrow and the reference numeral 1050.

In the case in which the SEAL-DD server/entity 1006 (e.g. at the DN/EDN side) is one or more of the available DetNet nodes (i.e. one or more of the nodes involved in the required communication link(s), and a part of the desired DetNet flow path), the NRM server 1004 also requests and receives from the SEAL-DD 1006 server the availability of the resources, i.e. sends a SEAL-DD/edge resource availability request and receives a SEAL-DD/edge resource availability response. The request may, for example, pertain to N6 resources (as captured from the DN side) and/or an expected latency/channel losses were DetNet flow traffic to be routed via the SEAL-DD server 1006. This sending, by the NRM server 1004 to the SEAL-DD server 1006, of the SEAL-DD/edge resource availability request is indicated in FIG. 10 by a single-headed arrow and the reference numeral 1055. The receiving, by the NRM server 1004 from the SEAL-DD server 1006, of the SEAL-DD/edge resource availability response is indicated in FIG. 10 by a single-headed arrow and the reference numeral 1060.

The NRM server 1004, after collecting all resource availabilities and/or condition parameters in the form of respective resource availability responses, evaluates whether the requisite resources for establishment of the DetNet flow are available, and may also process the individual responses to aggregate/correlate the availability end-to-end (for example, by calculating the end-to-end latency based on latencies for each hop). Additionally, the NRM server 1004 may also use analytics for discovering an expected availability of the DetNet flows. This evaluating by the NRM server 1004 of whether the requisite resources for establishment of the DetNet flow are available is indicated in FIG. 10 by the reference numeral 1065.

The terminology “aggregate” and/or “correlate” may refer herein to the processing of availability and measurement reports per identified source (UE, network node) to derive an end-to-end resource availability indication. The aggregation may refer to the binding of different hops of the path from which the DetNet flow is expected to pass, for example the calculation of per hop latencies together with the calculation of processing latencies per network node (protocol/function processing) and the processing time for queuing delays etc. can be accounted to calculate the expected latency and check whether this is fulfilling the requirement. For other metrics like the channel losses, the correlation may refer to finding the maximum error rate or the expected fluctuations or distribution of error rate considering all hops and evaluating whether this is acceptable for the DetNet flows. Other examples can be also possible for throughput, jitter, QoE metrics and the correlation/aggregation or abstraction can be up to implementation.

In this embodiment, the NRM server 1004 subsequently sends a DetNet flow availability discovery response to the VAL server 1002. The DetNet flow availability discovery response may include an indication as to whether the network resources needed to satisfy a network resource requirement of the DetNet flow (as per the requirement information, e.g. the Yang profiles) are available.

In some embodiments, the VAL server 1002, upon receiving from the NRM server 1004 the DetNet flow availability discovery response, checks the availability of the nodes and the conditions e.g. latency, and choses the nodes which better fulfil the requirements, e.g. with less latency.

This sending, by the NRM server 1004 to the VAL server 1002, of the DetNet flow availability discovery response is indicated in FIG. 10 by a single-headed arrow and the reference numeral 1070.

Table 4 below provides a summary of information elements which may be included within the DetNet flow availability response.

TABLE 4
DetNet flow availability discovery response.

| Information | |
|---|---|
| element | Description |
| Result | Result includes success or failure of the DetNet |
| | flow availability discovery with the underlying |
| | network. |
| Identifiers & | Identifiers and addresses of the involved entities |
| addresses | (VAL UEs, UPF, SEAL DD server). |
| Per-hop resource | Reporting of resource availability sustainability per |
| availability | hop. |
| sustainability | |
| Per-hop resource | Reporting of resource conditions for a given hop. |
| conditions | |
| Network QoS | Parameters to be used for network handling per |
| parameters | hop (e.g. 5Qls, PQls, . . .). |
| per hop | |

Predictive or statistic resource availability
Predictive or statistic resource conditions

Thus, a procedure 1000 is provided for discovering the availability of resources of communication links required for the establishing and/or routing DetNet flows, wherein the end systems are DetNet-aware.

In another embodiment, there is provided a procedure and architecture for discovering the (proxy) availability of resources of communication links required for the establishing and/or routing DetNet flows, wherein the end systems are not DetNet-aware, i.e. are DetNet-unaware.

In some embodiments, as a precondition to this procedure, Oa UE(s) of interest has an established IP PDU Session, and includes a DS-TT and/or a SEAL NRM client (which is configured and connected to a corresponding SEAL NRM server).

FIG. 11 depicts the procedure 1100 for discovering the availability of resources of communication links required for the establishing and/or routing DetNet flows, wherein the end systems are DetNet-unaware.

In this embodiment, the network architecture comprises a VAL server 1102, a NRM server or DetNet-aware AF 1104, a SEAL-DD server 1106, a 5GC or OAM 1108, a VAL UE 1110 and a DetNet controller 1112. The VAL UE 1110 comprises a NRM client 1114 and a DS-TT 1116. In this embodiment, the VAL server 1102 is DetNet-unaware. The NRM server or DetNet-aware AF 1104 may be in accordance with one or more of the NRM servers described in embodiments above. The SEAL-DD server 1106 may be in accordance with one or more of the SEAL-DD servers described in embodiments above. The 5GC or OAM 1108 may be in accordance with the 3GPP system(s) described in embodiments above. The VAL UE 1110 may be in accordance with one or more of the UEs described in embodiments above. The NRM client 1114 and/or the DS-TT 1116 may, respectively, be in accordance with the NRM clients and the DS-TTs described in embodiments above.

In this embodiment, the NRM server 1104 receives a request from the VAL server 1102 (which is a DetNet-unaware node/application-specific server), via a NRM-S reference point, to discover connectivity and available resources/QoS characteristics for one or more hops passing from at least one 3GPP networked node (e.g., Ues, a UPF, a SEAL-DD server, etc.) for a DetNet flow. In this embodiment, the request indicates the need to discover one or more DetNet nodes to be used for, i.e. to establish and route, DetNet flow traffic. The request may be considered a DetNet node and flow availability discovery request. This receiving by the NRM server or DetNet-aware AF 1104 of the DetNet node and flow availability discovery request from the VAL server 1102 is indicated in FIG. 11 by a single-headed arrow and the reference numeral 1120.

Table 5 below provides a summary of information elements which may be included within the DetNet flow availability discovery request in this embodiment.

TABLE 5
DetNet node and flow availability discovery request.

| Information | |
|---|---|
| element | Description |
| Requester | The identity of the entity performing the request. |
| Identity | |
| Request type | Request for discovery of DetNet nodes and/or |
| | request for discovery of resource availability. |
| Area of | The geographical or topological area for which the |
| interest/Service | request applies. |
| Area | |
| Time Validity | Time validity for the request. |
| S-NSSAI or | If application has preference on a certain slice or |
| Network Slice | slice instance, the discovery of resources can be |
| Instance (NSI) | for the requested slice based on S-NSSAI or NSI. |
| DNN/DNAI | Provides description on the DNN and/or DNAI |
| | when the DetNet node resides at the DN/EDN (this |
| | to be used for identifying the UPF). |
| Application Server | The VAL server or application or application profile |
| or VAL server | for which the discovery is requested. this is for the |
| ID, application | case when the request is indirectly provided via the |
| ID, application | requester (e.g. VAL server is behind the DetNet |
| profile or type | controller) |
| Reporting | Identifies how the reporting shall occur (e.g. based |
| configuration | on thresholds, periodically, event-based) |
| Information | the filter may specify a PLMN/NPN, a service |
| filter | provider |

In this embodiment, the NRM server or DetNet-aware AF 1104 discovers or fetches information on, or associated with, the DetNet controller 1112 for a given service area (depending on implementation, the controller 1112 may be centralized or distributed). Such information may be already know, in the case in which the NRM server 1104 is in fact the DetNet-aware AF 1104, or the information may be provided by the 5GC or OAM 1108 responsive to a request from the NRM server 1104. This discovering or fetching information on, or associated with, (e.g. the identity of) the DetNet controller 1112 for a given service area is indicated in FIG. 11 by a single-headed arrow and the reference numeral 1125.

In this embodiment, the NRM server or DetNet-aware AF 1104 requests, from the discovered DetNet controller 1112, requirement information, including Yang/Netconf traffic models (as described in draft-ietf-detnet-yang-16) which provide source/destination IP addresses as well as configurations for edge/relay/transit DetNet nodes. This requesting, by the NRM server or DetNet-aware AF 1104, the requirement information from the discovered DetNet controller 1112 is indicated in FIG. 11 by a single-headed arrow and the reference numeral 1130.

Table 6 below provides a summary of information elements which may be included within the request for requirement information.

TABLE 6
DetNet request for requirement information.

| Information | |
|---|---|
| element | Description |
| Requester | The identity of the VAL server performing the |
| Identity | request. |
| Requested | The requested information, such as the traffic |
| DetNet | profiles, the configurations, the specific nodes for |
| information | which the profiles apply, the IP addresses of the |
| | involved nodes, the KPIs associated per hop |
| | (latency, channel losses). |
| Area of | The geographical or topological area for which the |
| interest/Service | request applies. |
| Area | |
| Time Validity | Time validity for the request. |

In this embodiment, the DetNet controller 1112 sends to the NRM server or DetNet-aware AF 1104 the requested requirement information, including the Yang/Netconf traffic profiles. This sending, to the NRM server of DetNet-aware AF 1104 by the DetNet controller 1112, of the requirement information is indicated in FIG. 11 by a single-headed arrow and the reference numeral 1135.

Table 7 below provides a summary of information elements which may be included within the requirement information in this embodiment.

TABLE 7
DetNet requirement information.

| Information | |
|---|---|
| element | Description |
| DetNet | DetNet Yang traffic profiles including the app flows |
| profiles | and traffic profiles/characteristics. Such information |
| | may also include the mapping between app flows |
| | and DetNet flows (more than one app flow can |
| | correspond to a DetNet flow). |
| DetNet flow | App flow to DetNet flow mapping. |
| mapping | |
| List of DetNet | The list of the nodes and their type (edge, relay, |
| aware nodes | transit). |
| and types | |
| Service sublayer | If not provided in the profile. |
| configurations | |

In this embodiment, the NRM server or DetNet-aware AF 1104, based on the requirement information and the request of the VAL server 1102, translates the requirement information (e.g. the IP addresses of the traffic profiles and per-hop resource requirement information), into identities of the involved 3GPP nodes (e.g., Uu, PC5, based on the IP addresses), the required communication link(s) between the nodes, and the network resource requirements over these nodes (i.e. the resources required within 3GPP system for the sequence of transmissions/schedules for the DetNet flows. For such a translation, the NRM server or DetNet-aware AF 1104 may also query one or more nodes of the 5GC 1108, e.g. a Binding Support Function (BSF) via a Network Exposure Function (NEF), for the UE IDs, e.g. Generic Public Subscription Identifiers (GPSIs) associated with these IP addresses. This translating by the NRM server or DetNet-aware AF 1104 of the requirement information is indicated in FIG. 11 by the reference numeral 1140.

Depending on the types/identities of the required communication link(s) between the available nodes (e.g., UE-to-UE, or UE-to-UPF, or UE-to-SEAL-DD or UPF-to-SEAL-DD), the NRM server 1004 performs at least one pair of actions in accordance with the pairs of actions 1030, 1040; 1045, 1050; and 1055, 1060 of procedure 1000, as described above with reference to FIG. 10. That is to say, in this embodiment, procedure 1100 includes collecting, by the NRM server or DetNet-aware AF 1104, resource availabilities and/or condition parameters from various sources in the same manner as that in which the NRM server 1004 performs the corresponding collecting steps in the above-described embodiment of procedure 1000. In the case in which one of the identified DetNet nodes (i.e. one of the nodes involved in the required communication link(s)) is the VAL UE 1110, the NRM client 1114 interacts with the DS-TT 1116 thereby to calculate a resource availability and/or a condition parameter, in accordance with action 1035 in procedure 1000. In this embodiment of procedure 1100, this step, as in procedure 1000, occurs after the receiving by the VAL UE 1110 of the VAL UE resource availability request from the NRM server or DetNet-aware AF 1104, and before the sending by the VAL UE 1110 of the VAL UE resource availability response to the NRM server or DetNet-aware AF 1104.

This performance of one or more pairs of the collecting steps analogous to those of procedure 1000 is indicated in FIG. 11 by the reference numeral 1145.

In this embodiment, the NRM server or DetNet-aware AF 1104 sends a DetNet flow availability discovery response to the VAL server 1102, which can also indicate a set of nodes within a desired DetNet flow path, so as to provide the needed DetNet-awareness to the VAL server 1102. Such nodes may be, for example, the UPF of the 5GC 1108, the SEAL-DD server 1106, the VAL UE 1110 or a group of UEs that will be used as DetNet nodes. The NRM server or DetNet-aware AF 1104 may also indicate the ID and address of the DetNet controller 1112 to the VAL server 1102 to allow direct interaction between the server 1102 and the controller 1112 during the runtime operation phase.

The DetNet flow availability discovery response may include an indication as to whether the network resources needed to satisfy a network resource requirement of the DetNet flow (as per the requirement information, e.g. the Yang profiles) are available. This sending, by the NRM server or the DetNet-aware AF 1104 to the VAL server 1102, of the DetNet flow availability discover response is indicated in FIG. 11 by a single-headed arrow and the reference numeral 1150.

The information which may be included within the DetNet flow availability response in this embodiment is the same as that presented in Table 4 above.

In some embodiments, the VAL server 1102, upon receiving from the NRM server or DetNet-aware AF 1104 the DetNet flow availability discovery response, checks the availability of the nodes and the conditions e.g. latency, and choses the nodes which better fulfil the requirements, e.g. with less latency.

In this embodiment, the NRM server or DetNet-aware AF 1104 may also optionally send a notification to the DetNet controller 1112 of the availability discovery response (e.g. send to the DetNet controller 1112 a summary or part of the information included within the response, and/or a notification that certain resource requirement criteria have or have not been met, and/or a notification that a response has been provided to the VAL server 1102). The NRM server or DetNet-aware AF 1104 may also optionally provide details (VAL server ID, VAL client ID) of the DetNet-unaware VAL server 1102 node to the DetNet controller 1112.

This sending, by the NRM server or the DetNet-aware AF 1104 to the DetNet controller 1112, of the notification of the availability discovery response is indicated in FIG. 11 by a single-headed arrow and the reference numeral 1155.

In some embodiments, the NRM server is a DetNet-aware AF or NF (SA2). In other embodiments, the NRM server may be a management function of the OAM (SA5).

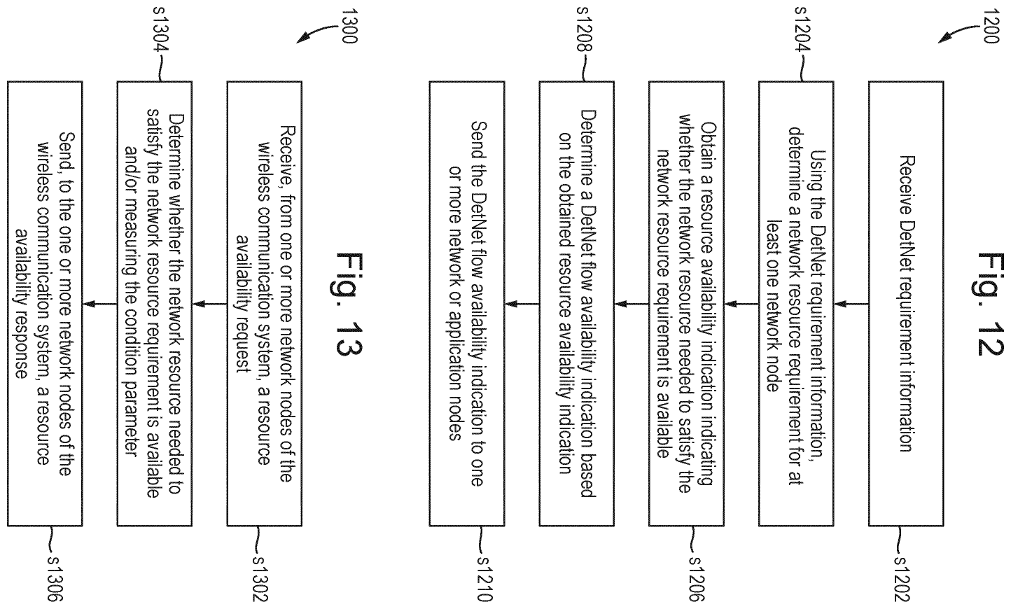

FIG. 12 depicts a flow chart showing steps of a method 1200 for performance by a network entity such as the NRM server described above. The method 1200 is a method for discovering availability of wireless communication system resources for at least one DetNet flow.

The method 1200 includes, at step s1202, receiving DetNet requirement information. The requirement information may be a requirement or request to support DetNet flow resource availability management, and/or a requirement or request to provide or discover the connectivity and available resources/QoS characteristics for one or more hops passing from at least one 3GPP networked node (e.g. a UE, UPF, SEAL-DD) for the at least one DetNet flow. The requirement information may include DetNet (e.g. Yang) traffic profiles as described in embodiments above. The receiving the DetNet requirement information may be performed in accordance with the receiving 1020 by the NRM server 1004 of requirement information from the VAL server 1002 as described with reference to FIG. 10 above. The receiving the DetNet requirement information may be performed in accordance with the receiving 1120 by the NRM server 1004 of requirement information from the DetNet controller 1112 as described with reference to FIG. 11 above.

The method 1200 includes, at step s1204, using the DetNet requirement information, determining a network resource requirement for at least one network node. The network node may be a core node or a RAN node of a 3GPP system. The network node may be a UE in accordance with the UEs 1010, 1110 described above. The network node may be a relay node for the DetNet flow. The network resource requirement may specify one or more network nodes and a requirement on one or more resources over those one or more nodes. The network resource requirement may include a network node selection requirement, or a network node configuration requirement, or a communication requirement between two or more network nodes, or a combination thereof. The using the DetNet requirement information to determine a network resource requirement for at least one network node may be performed in accordance with the translating 1025 by the NRM server 1004 of the requirement information as described with reference to FIG. 10 above. The using the DetNet requirement information to determine a network resource requirement for at least one network node may be performed in accordance with the translating 1140 by the NRM server or DetNet-aware AF 1104 of the requirement information as described with reference to FIG. 11 above.

The method 1200 includes, at step s1206, obtaining a resource availability indication indicating whether the network resource needed to satisfy the network resource requirement is available, e.g. available at or by the at least one network node. Step s1206 may include obtaining a resource availability indication indicating whether the network resource requirement is, or can/could be, satisfied. The obtaining a resource availability indication indicating whether the network resource needed to satisfy the network resource requirement is available may be performed in accordance with one or more of the actions 1040, 1050, 1060 as described with reference to FIG. 10 above.

The method 1200 includes, at step s1208, determining a DetNet flow availability indication based on the obtained resource availability indication. The DetNet flow availability indication may be considered an indication as to whether the at least one network node is capable of providing the resources necessary for establishing and routing DetNet flow traffic. The determining a DetNet flow availability indication based on the obtained resource availability indication may be performed in accordance with the evaluating 1065 by the NRM server 1004 of whether the requisite resources for establishment of the DetNet flow are available as described with reference to FIG. 10 above.

The method 1200 includes, at step s1210, sending the DetNet flow availability indication to one or more network or application nodes. The one or more network or application nodes may be nodes of a VAL server. The sending the DetNet flow availability indication to one or more network or application nodes may be performed in accordance with the sending 1070, by the NRM server 1004 to the VAL server 1002, of the DetNet flow availability discovery response as described with reference to FIG. 10 above.

In some embodiments, if the DetNet flow availability indication indicates that the network resource needed to satisfy the network resource requirement is available, the DetNet flow may be established using some or all resources available (e.g. the resources that satisfy the network resource requirement) to the at least one network node (e.g. a UE or a UPF or a SEAL DD server). The establishment of the DetNet flow may be performed by the DetNet end system or more generally the DetNet nodes (e.g. edge nodes, relay nodes). The establishment of the DetNet flow may be performed by any appropriate entity in any appropriate way.

In some embodiments, if the DetNet flow availability indication indicates that the network resource needed to satisfy the network resource requirement is not available, a DetNet-aware NRM server and/or a DetNet-aware AF, or a DetNet controller, or another DetNet-aware entity may select one or more other nodes to provide resources for establishing and routing the DetNet flow, and/or may perform the method 1200 in respect of the one or more other nodes.

In this embodiment, the DetNet requirement information may comprise one or more parameters selected from the group of parameters consisting of: a key performance indicator for the DetNet traffic; a DetNet traffic model; an identifier for one or more end nodes; an address for one or more end nodes; an identifier for one or more network nodes; an address for one or more network nodes; per hop performance requirements; a configuration of nodes and communication links; and a request for managing DetNet flow availability. The DetNet requirement information may further comprise one or more parameters selected from the group of parameters consisting of: a requester identity; a DetNet profile for the at least one DetNet flow; a DetNet Yang traffic profile for the at least one DetNet flow; an Area of interest, e.g. a Service Area for which the request/requirement information applies; a time validity, e.g. a time period for which the request/requirement information is valid; a single-network slice selection assistance information, S-NSSAI; a data network name, DNN; a data network access identifier, DNAI; a request type; a DetNet flow mapping; a list of DetNet-aware nodes; a type for one or more DetNet-aware nodes; and a service sublayer configuration. The DetNet requirement information may be in accordance with the DetNet requirement information described above with reference to FIGS. 10 and 11.

The DetNet requirement may be received from one or more entities selected from the group of entities consisting of: a VAL server; a DetNet controller; a DetNet node; a DetNet system; a network node; and a management node.

The DetNet flow availability indication may be sent to one or more entities selected from the group of entities consisting of: a VAL server; a DetNet controller; a DetNet node; a DetNet system; a network node; and a management node.

The network resource requirement may specify a requirement for a network resource, the network resource being selected from the group of network resources consisting of: a network parameter; a radio resource; a computational resource; a device; a router; a network node function; a network node protocol; a KPI; an energy resource; and a combination thereof.

The resource availability indication may be obtained from one or more entities selected from the group of entities consisting of: a UE; a UPF; a control plane network function (e.g. an SMF, or an NWDAF); and a SEAL-DD server.

The obtaining a resource availability indication at step s1206 may further comprise: sending a resource availability request to the at least one network node, the resource availability request requesting the resource availability indication and/or a condition parameter; and receiving, from the at least one network node, a resource availability response indicating the requested resource availability indication and/or the condition parameter. The sending a resource availability request to the at least one network node may be performed in accordance with the sending 1030 by the NRM server 1004 of the VAL UE resource availability request to the NRM client 1012 of the VAL UE 1010 as described with reference to FIG. 10 above. The receiving, from the at least one network node, a resource availability response indicating the requested resource availability indication and/or the condition parameter may be performed in accordance with the sending 1040 of the VAL UE resource availability response by the VAL UE 1010 to the NRM server 1004 as described with reference to FIG. 10 above.

The condition parameter may be a measurement of a condition (e.g. with respect to, or of, the at least one network node) selected from the group of conditions consisting of: load, latency, channel losses, measurement time period, aggregation granularity, jitter, throughput, and performance. The condition parameter may be in accordance with the condition parameter described above with reference to FIGS. 10 and 11.

The method 1200 may further comprise, using the DetNet requirement information, determining one or more further network resource requirements for one or more further network nodes. This may include translating the DetNet requirement information to identify one or more further network resource requirements for one or more further network nodes, e.g. in accordance with action 1025 as described with reference to FIG. 10 above. The method 1200 may further comprise obtaining one or more further resource availability indications indicating whether one or more further network resources needed to satisfy the one or more further network resource requirements are available (e.g. at or by the one or more further network nodes), e.g. in accordance with one or more of the pairs of actions 1045, 1050 and 1055, 1060 described with reference to FIG. 10 above. In this embodiment, the determining the DetNet flow availability indication may be further based on the one or more further resource availability indications.

Determining the DetNet flow availability indication based on the one or more further resource availability indications may comprise aggregating and/or correlating the one or more further resource availability indications with the resource availability indication. The determining the DetNet flow availability indication based on the one or more further resource availability indications may be performed in accordance with the evaluating 1065 by the NRM server 1004 whether the requisite resources for establishment of the DetNet flow are available as described with reference to FIG. 10 above.

Thus, a method 1200 for discovering availability of wireless communication system resources for at least one DetNet flow is provided.

In an embodiment, there is provided a network node of a wireless communication system. The network node may be in accordance with the network node 900 described above with reference to FIG. 9. The network node may be configured to perform the method 1200.

In this embodiment, the network node comprises a receiver which may be in accordance with the receiver 935 described above, one or more processors which may be in accordance with the processor 905 described above, and a transmitter which may be in accordance with the transmitter 930 described above. The receiver is arranged to receive DetNet requirement information, e.g. in accordance with step s1202 of the method 1200. The one or more processors are arranged to, using the DetNet requirement information, determine a network resource requirement for at least one other network node, e.g. in accordance with step s1204 of the method 1200. The one or more processors are further arranged to, using the DetNet requirement information, obtain a resource availability indication indicating whether a network resource needed to satisfy the network resource requirement is available, e.g. in accordance with step s1206 of the method 1200. The one or more processors are further arranged to determine a DetNet flow availability indication based on the obtained resource availability indication, e.g. in accordance with step s1208 of the method 1200. The transmitter is arranged to send the DetNet flow availability indication to one or more network or application nodes, e.g. in accordance with step s1210 of the method 1200.

In this embodiment, the network node may be a NRM server, e.g. in accordance with the NRM server 1004 or 1104 described above. In some embodiments, the network node may be an AF (e.g. a Detnet-aware AF), a core NF, an OAM function, a SEAL DD server, a Time Sensitive Communication Time Synchronization Function, TSCTSF or a combination thereof.

FIG. 13 depicts a process flow chart depicting a further method 1300 for performance by a UE, e.g. the UE 1010 and/or 1110 described above, for discovering availability of wireless communication system resources for at least one DetNet flow.

The method 1300 includes, at step s1302, receiving, from one or more network nodes of the wireless communication system, a resource availability request. The resource availability request comprises one or both of: a request for an indication as to whether a network resource needed to satisfy a network resource requirement for a DetNet flow is available; and a request for a condition parameter for a network resource associated with the DetNet flow. The receiving, from one or more network nodes of the wireless communication system, a resource availability request may be performed in accordance with action 1030 described with reference to FIG. 10 above.

The method 1300 includes, at step s1304, determining whether the network resource needed to satisfy the network resource requirement is available and/or measuring the condition parameter. Step s1304 may include determining whether the network resource requirement is, or can/could be, satisfied. The determining whether the network resource needed to satisfy the network resource requirement is available and/or measuring the condition parameter may be performed in accordance with the interacting 1035 of the NRM client 1012 with the DS-TT 1014 thereby to calculate a resource availability and/or a condition parameter as described with reference to FIG. 10 above.

The method 1300 includes, at step s1306, sending, to the one or more network nodes of the wireless communication system, a resource availability response. the resource availability response comprising one or both of: a resource availability indication indicating whether the network resource needed to satisfy the network resource requirement is available; and the measurement of the condition parameter. The sending, to the one or more network nodes of the wireless communication system, a resource availability response may be performed in accordance with the sending 1040 of the VAL UE resource availability response by the VAL UE 1010 to the NRM server 1004 as described with reference to FIG. 10 above.

Thus, a further method 1300 for discovering availability of wireless communication system resources for at least one DetNet flow is provided.

In an embodiment, there is provided a UE. The UE may be in accordance with the UEs 800, 1010 and 1110 described above. The UE may be configured to perform the method 1300.

In this embodiment, the UE comprises a receiver which may be in accordance with the receiver 835 described above, one or more processors which may be in accordance with the processor 805 described above, and a transmitter which may be in accordance with the transmitter 830 described above.

The receiver is arranged to receive from one or more network nodes of the wireless communication system, a resource availability request, e.g. in accordance with step s1302 of the method 1300.

In this embodiment, the resource availability request comprises one or both of: a request for an indication as to whether a network resource needed to satisfy a network resource requirement for a DetNet flow is available; and a request for a condition parameter for a network resource associated with a DetNet flow. The resource availability request may be in accordance with the resource availability requests described above with respect to FIGS. 10 and 11. The one or more processors are arranged to: determine whether the network resource needed to satisfy the network resource requirement is available; and/or measure the condition parameter, e.g. in accordance with step s1304 of the method 1300. The transmitter is arranged to send, to the one or more network nodes of the wireless communication system, a resource availability response, e.g. in accordance with step s1306 of the method 1300. The resource availability response comprises one or both of: a resource availability indication indicating whether the network resource needed to satisfy the network resource requirement is available; and the measurement of the condition parameter. The resource availability indications may be in accordance with the resource availability indications described above with respect to FIGS. 10 and 11.

In some embodiments, the UE is an edge node UE, i.e. a node which forms an edge node of the DetNet flow. In other embodiments, the UE is a relay node UE, i.e. a node which relays DetNet traffic between end systems of the DetNet flow.

A problem that may be solved by the above-described methods and architectures is that of discovering the availability of resources, corresponding to the different hops within a 3GPP system (e.g., UE-to-UE and UE-to-UPF) of an end-to-end DetNet flow path, required to support DetNet flow traffic. Analogous problems exist in the distinct cases in which the nodes and end systems of a network are DetNet-aware and in which the same are, in contrast, DetNet-unaware.

Advantageously, the above-described methods and architectures provide a mechanism by which an AF/SEAL NRM server may determine the resource availability and functional capabilities of entities within the wireless communication system (including UEs, UPFs, SEAL-DD/edge servers, etc.) to serve as communication end points/relay nodes for L3 DetNet use cases. Such a mechanism advantageously includes translating (e.g., Yang) traffic profiles into network resource requirements, and calculating whether these requirements can be fulfilled by identified 3GPP nodes on a per-hop (individual) and/or end-to-end (aggregated/correlated) basis within the 3GPP domain/realm.

Although existing TSN AFs/SEAL NRM servers provide some configuration and translation capabilities for TSN traffic, only L2 DetNets are supported. In particular, the 5GS acts as a L2 bridge. Since, in the TSN/TSC use case, the translation happens at the IP level, the resource requirements for DetNet flow establishment/routing and the capabilities of entities to be involved in the process may be different. Hence, no solution has hitherto existed for the same problem, i.e. determining resource availability and DetNet flow establishment capability, within 3GPP systems. An alternative solution would be for the DetNet controller to coordinate the entire procedure, with the resource availability of the 3GPP nodes being assumed fixed (e.g. with overprovisioning of resources at all involved nodes). However, such alternatives may be suboptimal in dynamic environments, and are limited in their implementation to fully centralized deployments only.

Advantageously, the embodiment of the procedure 1000 described with reference to FIG. 10 provides a mechanism which is compliant with 3GPP SA6 architecture and is based on a request from a VAL server (which can itself be a DetNet controller), wherein the resource availability discovery for involved nodes is provided by DetNet-aware end systems.

Advantageously, the embodiment of the procedure 1100 described with reference to FIG. 11 provides a mechanism which is compliant with 3GPP SA6 architecture and is also based on a request from a (DetNet-unaware) VAL server, wherein interaction with a (DetNet-aware) DetNet controller is supported to provide the resource and node availability discovery for involved nodes despite the end systems being DetNet-unaware.

Advantageously, each of the respective embodiments of FIGS. 10 and 11 may be realized using both SA2 (wherein the network node is a DetNet-aware AF which interacts with a 5GC, OAM, DN, DS-TT, etc.) and SA5 architectures (wherein the network node is an OAM function which interacts with 3rd party and managed functions).

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

Further aspects of the invention are provided by the subject matter of the following clauses:
1. A method for discovering the availability of wireless communication system resources for at least one deterministic flow, the method comprising: receiving a DetNet requirement to support the DetNet flow resource availability management; translating the DetNet requirement to a network resource requirement for at least one network nodes in the wireless communication system, wherein the network resource requirement is a network node selection requirement, a network node configuration requirement, a communication requirement between two or more network nodes, or a combination thereof; obtaining from the at least one network nodes information on the network resources, based on the network requirement; determining a DetNet flow availability indication based on the obtained information; and sending the DetNet flow availability indication to one or more network or application nodes.
2. A method according to any preceding clause, wherein the DetNet requirement comprises at least one of the following: a key performance indicator for the DetNet traffic, a DetNet traffic model, identifiers and addresses for one or more end nodes, identifiers and addresses for one or more network nodes, per hop performance requirements, configuration of nodes and communication links, a request for managing DetNet flow availability.
3. A method of any preceding clause, wherein the DetNet requirement is received from a VAL server, a DetNet controller, a DetNet node, a DetNet system, a network node, a management node. or a combination thereof.
4. A method of any preceding clause, wherein the resource comprises a network parameter, a radio resource, a computational resource, a device, a router, a network node function, a network node protocol, a KPI, an energy resource, or a combination thereof.
5. A method of any preceding clause, wherein the detent flow availability is based on the resource load and/or performance.
6. A method of any preceding clause, wherein obtaining comprises: requesting an availability and/or condition parameter from at least one network node; and receiving the availability and/or condition parameter from the at least one network node;
7. A method of any preceding clause, further comprising correlating the resource availabilities and condition parameters over different hops to provide the DetNet flow availability.
8. A method of any preceding clause, wherein sending the DetNet flow availability indication comprises providing one or more resource discovery reports to the app server/DetNet controller, based on the requirement and the processing provided.

What is claimed is:

1-15. (canceled)

16. A network node for wireless communication, comprising;
at least one memory; and
at least one processor coupled with the at least one memory and configured to cause the network node to:
determine, using deterministic network requirement information, a network resource requirement for at least one other network node;
obtain a resource availability indication indicating whether a network resource needed to satisfy the network resource requirement is available;
determine a deterministic network flow availability indication based on the obtained resource availability indication; and
send the deterministic network flow availability indication to one or more network nodes or application nodes.

17. The network node of claim 16, wherein deterministic network requirement information comprises one or more parameters comprising one or more of:
a key performance indicator for deterministic network traffic;
a deterministic network traffic model;
an identifier for one or more end nodes;
an address for the one or more end nodes;
an identifier for one or more network nodes;
an address for the one or more network nodes;
per hop performance requirements;
a configuration of nodes and communication links; or
a request for managing deterministic network flow availability.

18. The network node of claim 16, wherein the deterministic network requirement information comprises one or more parameters comprising one or more of:
a requester identity;
a deterministic network profile for at least one deterministic network flow;
a deterministic network Yang traffic profile for the at least one deterministic network flow;
an area of interest;
a time;
H a single-network slice selection assistance information (S-NSSAI);
a data network name (DNN);
a data network access identifier (DNAI);
a request type;
a deterministic network flow mapping;
a list of deterministic network-aware nodes;
a type for one or more deterministic network-aware nodes; or
a service sublayer configuration.

19. The network node of claim 16, wherein the deterministic network requirement information is received from one or more of:
a vertical application layer (VAL) server;
a deterministic network controller;
a deterministic network node;
a deterministic network system;
a network node; or
a management node.

20. The network node of claim 16, wherein the deterministic network flow availability indication is sent to one or more of:
a vertical application layer (VAL) server;
a deterministic network controller;
a deterministic network node;
a deterministic network system;
a network node; or
a management node.

21. The network node of claim 16, wherein the network resource requirement specifies a requirement for a network resource, the network resource comprising one or more of:
a network parameter;
a radio resource;
a computational resource;
a device;
a router;
a network node function;
a network node protocol;
a key performance indicator (KPI); or
an energy resource.

22. The network node of claim 16, wherein the resource availability indication is obtained from one or more of:
a user equipment (UE);
a user plane function (UPF);
a control plane network function; or
a service enabler architecture layer data delivery (SEAL-DD) server.

23. The network node of claim 16, wherein to obtain the resource availability indication, the at least one processor is configured to cause the network node to:
send a resource availability request to the at least one other network node, the resource availability request requesting one or more of the resource availability indication or a condition parameter; and
receive, from the at least one other network node, a resource availability response indicating the one or more of the requested resource availability indication or the condition parameter.

24. The network node of claim 23, wherein the condition parameter comprises a measurement of a condition comprising one or more of: load, latency, channel losses, jitter, throughput, measurement time period, aggregation granularity, or performance.

25. The network node of claim 16, wherein the at least one processor is configured to cause the network node to:
determine, using the deterministic network requirement information, one or more further network resource requirements for one or more further network nodes; and
obtain one or more further resource availability indications indicating whether one or more further network resources needed to satisfy the one or more further network resource requirements are available,
wherein the determining the deterministic network flow availability indication is further based on the one or more further resource availability indications.

26. The network node of claim 25, wherein the determining the deterministic network flow availability indication comprises correlating the obtained resource availability indication with the obtained one or more further resource availability indications.

27. A method performed by a network node, the method comprising:
determining, using deterministic network requirement information, a network resource requirement for at least one other network node;
obtaining a resource availability indication indicating whether a network resource needed to satisfy the network resource requirement is available;
determining a deterministic network flow availability indication based on the obtained resource availability indication; and
sending the deterministic network flow availability indication to one or more network nodes or application nodes.

28. The method of claim 27, wherein the network node comprises one or more of a network resource management (NRM) server, a deterministic network (DetNet)-aware application function (AF), an operations, administration, and maintenance (OAM) function, a service enabler architecture layer data delivery (SEAL-DD) server, or a time sensitive communication time synchronization function (TSCTSF).

29. A user equipment (UE) for wireless communication, comprising:
at least one memory; and
at least one processor coupled with the at least one memory and configured to cause the UE to:
receive, from one or more network nodes, a resource availability request, the resource availability request comprising one or more of:
a request for an indication as to whether a network resource needed to satisfy a network resource requirement for one or more of a deterministic network or a deterministic network flow is available; or
a request for a condition parameter for a network resource associated with the deterministic network flow;
perform one or more of determining whether the network resource needed to satisfy the network resource requirement is available or measuring the condition parameter; and
send, to the one or more network nodes, a resource availability response, the resource availability response comprising one or more of:
a resource availability indication indicating whether the network resource needed to satisfy the network resource requirement is available; or
a measurement of the condition parameter.

30. The UE of claim 29, wherein the network resource requirement specifies a requirement for a network resource, the network resource comprising one or more of:
a network parameter;
a radio resource;
a computational resource;
a device;
a router;
a network node function;
a network node protocol;
a key performance indicator (KPI); or
an energy resource.

31. The UE of claim 29, wherein the condition parameter comprises one or more of load, latency, channel losses, jitter, throughput, measurement time period, aggregation granularity, or performance.

32. The UE of claim 29, wherein to perform one or more of determining whether the network resource needed to satisfy the network resource requirement is available or measuring the condition parameter, the at least one processor is configured to cause the UE to interact with a network resource management (NRM) client with a device side time-sensitive networking translator (DS-TT).

33. A processor for wireless communication, comprising:
at least one controller coupled with at least one memory and configured to cause the processor to:
receive, from one or more network nodes, a resource availability request, the resource availability request comprising one or more of:
a request for an indication as to whether a network resource needed to satisfy a network resource requirement for one or more of a deterministic network or a deterministic network flow is available; or
a request for a condition parameter for a network resource associated with the deterministic network flow;
perform one or more of determining whether the network resource needed to satisfy the network resource requirement is available or measuring the condition parameter; and
send, to the one or more network nodes, a resource availability response, the resource availability response comprising one or more of:
a resource availability indication indicating whether the network resource needed to satisfy the network resource requirement is available; or
a measurement of the condition parameter.

34. The processor of claim 33, wherein the network resource requirement specifies a requirement for a network resource, the network resource comprising one or more of:
a network parameter;
a radio resource;
a computational resource;
a device;
a router;
a network node function;
a network node protocol;
a key performance indicator (KPI); or
an energy resource.

35. The processor of claim 33, wherein the condition parameter comprises one or more of load, latency, channel losses, jitter, throughput, measurement time period, aggregation granularity, or performance.
